(19) United States
(12) Patent Application Publication
(10) Pub. No.: US 2008/0062997 A1
(43) Pub. Date: Mar. 13, 2008

(54) Intelligent call routing through distributed VoIP networks

(75) Inventor: John A. Nix, Evanston, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Go2Call.com, Inc., Evanston, IL (US)

(21) Appl. No.: 11/516,907

(22) Filed: Sep. 7, 2006

(51) Int. Cl. H04L 12/56

(52) U.S. Cl. 370/395.2

(57) ABSTRACT

Methods and systems are provided for intelligent call routing through distributed VoIP networks. A host name, representing a proxy, is assigned to and associated with a device. An IP address of a first proxy is acquired via a DNS query for the host name. The quality of the connection between the first proxy and the device is measured at least in part by calculating the round-trip delay for messages between the first proxy and the device. A DNS record for the host name is changed to specify the IP address of a second proxy. The IP address of the second proxy is acquired via a second DNS query for the host name. The quality of the connection between the second proxy and the device is measured at least in part by calculating the round-trip delay for messages between the second proxy and the device. The quality of the first and second connections is compared, and the IP address of the proxy with the higher-quality connection is assigned to the DNS record.

### BACKGROUND

1. Technical Field

The present methods and systems relate to voice communications over packet-switched networks and, more particularly, to server-based methods for optimizing the routing of Voice-over-Internet-Protocol (VoIP) calls.

2. Description of Related Art

Public packet-switched networks have recently supported voice and video communications. “Internet telephony” is one example of packet-switched telephony. In packet-switched telephony, a packet-switched network such as the Internet, serves as a transportation medium for packets carrying voice data. Voice-over-Internet-Protocol (VoIP) is one example of a collection of standards and protocols used to support voice or video communications over packet-switched networks such as the Internet. Others have been developed as well. A common Internet telephony scheme involves a computer or other device that is capable of connecting to the Internet. For many VoIP applications, the computer or device registers with a proxy server and media flows through a media server, although other configurations are possible.

Numerous benefits may be realized through the use of packet-switched telephony. For example, calls may be less expensive because of the utilization of a packet-switched network, such as the Internet, to traverse distances around the world. This is in contrast to conventional telephone service, which typically involves tying up telephone circuits to connect calls. Thus, a user in one location may communicate with a subscriber at a second location by transmitting voice data across the Internet, in order to avoid paying some or all of the long distance fees that might otherwise be associated with making such a call. The subscriber in the second location may also be connected to the Internet via a second user device or may have a regular telephone handset that is accessed from the Internet via a gateway.

Another possible advantage of packet-switched telephony service is the convenient interfaces and features that may be offered in a packet-switched telephony system. For example, voice mail, a video session, or an address book application may be implemented. Many Internet Telephony Service Providers (ITSPs) have been formed in order to provide these services. Examples of ITSPs include Go2Call.com, Skype, Google Talk, Yahoo, Vonage, and others. Each ITSP generally has its own features and calling rates, such as address books, free PC-to-PC voice or video calls, and paid calling to international telephone numbers or mobile telephones. Many services require either the download of client software or installation of an IP phone, video phone, or analog telephone adapter (ATA), each of which implement various VoIP protocols in order to communicate voice and/or video across the Internet.

Many of the above ITSPs have realized significant increases in both the number users and the number of servers needed to support the increased number of telephone calls and minutes that traverse their networks. Since the Internet is a global network, end users for many ITSPs are distributed around the world. The distributed nature of both end users and servers creates significant challenges to ITSPs in order to optimize the routing of the call for each user device or software application. The optimal routing of calls through the Internet is very important to obtain high quality of the call, and improper routing will often result in delays, lost packets, insufficient bandwidth, and various distortions of the voice or video that are noticeable to one or both end users of a VoIP call or video session.

As the use of VoIP has grown significantly over the past several years, various methods have emerged to improve the quality of a voice call across the Internet. In general, these methods can enhance the quality of a call, although they do not provide a server-based method for optimizing call routing that is fully compliant with widely-implemented standards on user devices. One method includes the use of Forward Error Correction (FEC) in order to compensate for packet loss (Jang and Schulzrinne at Columbia, “Comparisons of FEC and Codec Robustness on VoIP Quality”, 2003).

Another method is the utilization of codecs considered as frame independent such as iLBC or G.711, as opposed to codecs with higher interframe dependencies such as G.723.1 or G.729. With frame-independent codecs, if one packet is lost, then the loss and distortion of media will generally not propagate to subsequent frames. Other approaches to improving voice quality include implementing advanced logic on the VoIP endpoints to optimize jitter buffers, provide packet-loss-concealment mechanisms, and the implementation of higher-fidelity codecs such as G.729 Annex E. Finally, ITSPs and technology vendors to the ITSPs may combine the above VoIP-quality-enhancement mechanisms in order to deliver improved quality voice (Global IP Sound, Inc.).

The above methods for improving voice quality are incomplete if the ITSP does not seek the optimal routing of the media from user devices through the Internet to their servers. For example, delay in hearing voice spoken at the distant device is primarily the result of the network delay required to transmit the packets across the Internet. Outside of jitter-buffer optimization to reduce the jitter buffer size, software on either endpoint is generally not capable of significantly reducing the inherent network delay and jitter.

Packet switching on the public Internet is almost universally provided as a “best effort” service. This means that very often neither the end user nor the ITSP has complete control over the routing of a VoIP call from end to end through the Internet. The sequence of hops taken by any packet is determined by the Internet routers, which often are under the control of several different ISPs on the path between the end user and the ITSP. The quality of the call will be affected by the quality of each individual hop, and important network quality parameters include delay, packet loss, jitter, bit errors, and out of order packets.

In addition, significant variation in network quality can be introduced via congestion, time of day or day of week, when an ISP changes their own routing rules, or occasionally upon significant network outages such as loss of power in a data center or the breakage of undersea fiber optic cables. However, an ITSP with servers distributed geographically in multiple cities or even multiple continents may have the ability to adjust the destination proxy or media server on their network in order to route around potential network issues and provide superior call routing across the network with corresponding higher voice clarity and reduced delay for end users.

Simple methods are available to ITSPs for reducing delay such as specifying proxy and media servers that are in the same geographical region as the end user. For example, an ITSP may have servers located at points of presence (PoPs) in Brazil and the United States. User devices that are deployed in South America may be configured so that the primary proxy and media server for the device is located in the Brazil PoP. However, the simple geographical method for selecting servers can result in routing that is not optimized and results in lower voice quality. For example, a user device served by the ITSP may be connected to an ISP in Bolivia and the Bolivian ISP may route all international Internet traffic first to the US. In this example, to reduce the number of Internet hops and minimize delay, the ITSP should use the proxy and media servers located in the US PoP as opposed to the Brazil PoP, since the media packets will traverse the US before routing back to Brazil.

Simple geographical methods also do not address the optimal selection of a server if multiple servers are located within the region. For example, an ITSP may have 2 PoPs within Sao Paulo, Brazil, and thousands of user devices located within the same region. The end users may be served by multiple ISPs, and each ISP has its own peering arrangements and Internet routing rules. In this example, simple geographical rules are not helpful, since the PoPs and user devices belong to the same geographical region.

Another straightforward alternative to geographical routing would be to evenly distribute the user devices across available proxies, providing the benefit of distributing the load, but this alternative would not provide an optimal routing solution for each individual device. With multiple PoPs and thousands or more devices in the same geographical region, each device will have a superior route option among the available servers, which would correspond to the route with the lower delay, packet loss and jitter.

Further, underlying variation in network quality may change so that, for a particular user device, one proxy server located in one PoP may provide superior routing on certain days of a month, while a second proxy server located in a second PoP may provide superior routing on the other days of the month, depending on the routing of packets across the Internet. The ITSP would like to specify the best server individually for every device on any given day, but simple geographical routing or uniform distribution will generally not provide an optimized solution.

Numerous methods have been proposed to improve call routing and selection of a server for a user device among multiple servers distributed on the Internet. However, these methods have several drawbacks for ITSPs, and do not leverage server-based solutions that rely entirely on widely-deployed VoIP protocols. A user device may be configured to issue periodic Packet Internet Groper (PING) or similar network-probing requests to several servers, to measure the network conditions from the device to each server. Primary network conditions for consideration include round-trip time or delay, packet loss, and jitter or variation in round-trip time.

There are several issues with methods that rely upon PINGs or similar network probes from the user device to measure network quality. First, the methods require proprietary programming on the device and do not leverage existing Internet Engineering Task Force (IETF) VoIP standards such as Session Initial Protocol (SIP). Worldwide, there are hundreds of models of IP phones and VoIP devices, and the vast majority does not have intelligence on the device to select a server with an optimized route. Second, PINGs are dropped by many ISPs, such as Saudi Telecommunications Company in Saudi Arabia, which means that user devices on the network will not be able to readily measure the quality of routes to different servers.

Third, the introduction of pings specifically for the measurement of network quality results in unnecessary network traffic. Fourth, PINGs or similar network probes from the client do not readily support dynamic updates of the list of servers that are monitored by the user device. For example, the service provider may add a new server or PoP location, and the list of available servers would have to be updated on the device. Many times, a user device needs to be rebooted before a change in configuration will take place. Finally, if an end user device uses a PING or other network probe to locate the server with the best Internet path, the ITSP has reduced ability to intentionally spread the calls across multiple POPs. For example, user devices in a certain geographical region may heavily favor a particular PoP, even though spreading the calls across a second PoP in that geographical region with slightly lower quality may have overall greater net benefits to the service provider due to the distributed load.

Many other proposed solutions to the problem of finding the optimized route for VoIP or video calls rely upon PINGs or similar network probes from the server. One benefit of probing from the server is that the technique does not require proprietary software to be downloaded and installed on the user devices, and thus industry-standard IP phones and ATAs can be supported by the ITSP with various server-based techniques. However, probing the network from the ITSP servers still creates challenges that may result in less-than-optimal routing solutions.

First, many user devices are behind a network-address-translation device (NAT), which will drop standard PINGs to the end user device, since a private-IP-address scheme is commonly used behind NATs, and private IP addresses are not routable on the public Internet. Likewise, a network probe from the server to the user device behind a NAT may frequently be dropped if the NAT port is not open and properly specified. As noted above with client-based network probes, an intermediate ISP or firewall on the Internet may intentionally drop PINGs for security purposes, such as to prevent denial of service (DOS) attacks such as the “ping of death” or “flood pings”. Finally, the use of PINGs or server-based network probes generates unnecessary network traffic.

With a server-based-PING or network-probing solution, once the ITSP selects the proxy or media server providing the optimal Internet route, the user device will need to download a new configuration file to specify the selected proxy. The user device will have to apply the configuration file, which may require a reboot of the user device. Although the server-based-PING solution bypasses the need for proprietary code on user devices, it introduces significant complexity in the downloading and applying of a new configuration file every time the ITSP adjusts routing for each individual device, which may be as frequently as several times a day in order to deliver the highest possible voice quality with rapidly changing network conditions.

Routing of calls or video sessions between user devices and the ITSP is particularly important for support of network address translation (NATs) and firewalls, even if the call is considered to be “on net” or between two user devices connected to the Internet. Although the “ideal” routing of the media for a call between two endpoints on the Internet may be the direct transmission of the media between the endpoints, in many cases the media cannot be directly transmitted because the endpoints reside behind NATs at private IP addresses that are not routable across the Internet.

For one, a relay on the public Internet is required to bridge a call between two endpoints that are both behind symmetric NATs. In addition, the user devices may not implement FEC or have compatible codecs, so the ITSP can enhance the call quality and completion rates by implementing FEC on the server or converting the media between two user devices that have implemented incompatible codecs. Finally, although multiple schemes have been developed to support the direct transmission of media between user devices, such as the Internet Connectivity Establishment (ICE), such schemes only optimally work if the devices for both parties of a call have implemented the same standard. Millions of user devices currently deployed worldwide have not implemented ICE or other standardized techniques for the direct transmission of media between two devices connected to the Internet behind NATs. In order to support calling between these devices, the media may need to be routed through the ITSPs' servers, and the optimal server for routing that media will need to be selected by the ITSP.

In order to provide superior routing of VoIP calls from geographically-distributed user devices to a network of geographically-distributed proxy and media servers, an ITSP needs a solution to the significant noted limitations of simple geographical routing, uniform distribution, client-based probes, or server-based probes. The solution should be compatible with existing standards widely deployed by manufacturers of IP phones, ATAs, and soft phones, to avoid the need for implementation of specialized software on user devices. The solution should require minimal or ideally no changes or updates to the configuration files of the user devices in order to adjust the routing and select the optimal server for each device.

Ideally, the ITSP server that provides optimal routing can be determined and specified from server-based techniques, while simultaneously supporting existing user devices. Plus, the solution should be scalable, to simplify the process of obtaining and optimizing the routing individually for millions of user devices—distributed around the world—connecting with an ITSP network containing hundreds of servers that are also distributed globally. Finally, the solution should allow automated optimization of the network on a per-device basis, so the network quality from each individual device to different servers can be measured, and the optimal server selected for an individual device, without impacting the function of any other user device on the ITSP's network.

### SUMMARY

Methods and systems are provided for intelligent call routing through distributed Voice over IP (VoIP) networks. One embodiment may take the form of a method for selecting a packet-switched VoIP proxy server. In accordance with the method, a host name is assigned to a user device. The host name represents a first proxy server for communicating call control with the user device, and the host name is associated with the user device. An IP address of the first proxy server is acquired via a first Domain Name System (DNS) query for the host name associated with the user device. The quality of a first network connection between the first proxy server and the user device is measured a at least in part by calculating the round-trip delay for messages between the first proxy server and the user device.

Further in accordance with the embodiment, a DNS record for the host name associated with the user device is changed to specify an IP address of a second proxy server for communicating call control with the user device. The IP address of the second proxy server is acquired via a second DNS query for the host name associated with the user device. The quality of a second network connection between the second proxy server and the user device is measured at least in part by calculating the round-trip delay for messages between the second proxy server and the user device. The quality of the first and second network connections is recorded in a database. The quality of the first and second network connections is compared. The IP address of the proxy server associated with the higher-quality network connection is assigned to the DNS record for the host name associated with the user device.

These as well as other aspects and advantages will become apparent to those of ordinary skill in the art by reading the following detailed description, with reference where appropriate to the accompanying drawings.

### BRIEF DESCRIPTION OF THE DRAWINGS

Various exemplary embodiments are described herein with reference to the following drawings, wherein like numerals denote like entities.

FIG. 1 is a graphical illustration of an exemplary packet-switched telephony system;

FIG. 2 is a graphical illustration of a system to configure a user device for communicating with the ITSPs network, including the use of a host name for the proxy that is associated with the user device;

FIG. 3 is a preferred flow sequence for assigning to the device a host name associated with the device as the ITSP proxy for the device;

FIG. 4 is a simplified message flow diagram illustrating confirmed messages from the server to the user device with the recorded timestamps to measure network delay;

FIG. 5 illustrates the detailed messages and time stamps between the server and the user device for a registration request, a “401 Unauthorized” challenge, and a second registration request in response to the challenge;

FIG. 6 is a simplified block diagram illustrating the device registration process utilizing the host name and DNS record associated with the device and time-to-live values;

FIG. 7 is a simplified block diagram illustrating an exemplary embodiment measuring the network delay between a user device and a proxy through a challenge and response;

FIG. 8 is a simplified tabular summary illustrating multiple network delay measurements between a user device and a proxy;

FIG. 9 is a graphical illustration of measuring the network quality from a device to geographically distributed proxy servers;

FIG. 10 is a simplified block diagram illustrating an exemplary embodiment selecting the proxy with the highest network quality between the user device and proxy;

FIG. 11 is an illustration of database tables of an exemplary embodiment for proxy servers, and device host names;

FIG. 12 is an illustration of a database tables of and exemplary embodiment for recording the network delay across multiple devices and proxies, as well as calculating the mean opinion score for multiple proxies to a single device;

FIG. 13 is an illustration of a database table for assigning proxy server IP addresses to the device host names;

FIG. 14 is a simplified block diagram illustrating the logic to adjust the “time to live” parameters of the DNS record, based upon the variability of measured network quality between proxy servers and a user device;

FIG. 15 is a simplified network diagram illustrating an exemplary embodiment for the use of a media server;

FIG. 16 is an illustration of an exemplary embodiment where media servers report call quality statistics;

FIG. 17 is an illustration of a database recording the call quality from media servers and associating media servers with proxy servers; and

FIG. 18 is an illustration of an exemplary embodiment where device-specific host names are used to direct client devices to particular servers.

### DETAILED DESCRIPTION OF EXEMPLARY EMBODIMENTS

User devices such as IP phones, ATAs, and soft phones running on PCs or user devices contain configuration parameters to specify the destination network addresses for communicating call requests and media. ITSPs provide configuration parameters to the user devices to provide service such as voice or video calls, conference calls, or voice mail. For SIP-based networks, many user devices require the specification of a proxy or an outbound proxy in order to communicate call control and media. ITSPs provide configuration files with IP addresses or host names of servers on their network that correspond to the proxy and media servers, and these servers may be specified by the ITSP based upon the methods of optimized routing noted in the prior art above, such as simple geographical rules, client-based network probes, or server-based network probes.

A principle difference with the current methods and systems from the prior art is the use of host names in the device configuration fields for proxy or media servers not associated with the names of the ITSP servers, but rather with the end user device. By applying a host name associated with the user device instead of the ITSP network servers, the ITSP can selectively optimize the routing for the individual user device through server-based measurements of the network quality and adjust the DNS record for an individual device to select the best possible route, without requiring proprietary methods of measuring network quality to the various servers on the device.

In order to support traversal of messages such as incoming call requests through NATs, user devices frequently send out messages to the ITSP servers in order to maintain open “pin holes” in the NATs. A common example with SIP is the frequent transmission of a REGISTER request from the device to the proxy server. A device may send a REGISTER request every minute to ensure that the NAT pinhole remains open, so that an incoming INVITE from the server to the user device can be received and a voice or video session established to service a call from another device on the Internet. Alternative messages such as NOTIFY or OPTIONS can also be used from the user device in order to keep the NAT pinhole open. In addition, once a REGISTER is received by the proxy server, the proxy server can keep the NAT pinhole open by sending periodic messages such as NOTIFY or OPTIONS to the user device.

The present methods and systems utilize messages between the server and the device which require a confirmation of receipt from the user device back to the server. The time stamp and reliability of the response can be recorded on the server to measure the underlying network performance between the server and the user device. Since the standard configuration of many user devices requires several messages and responses per hour between the server and the device in order to keep NAT pinholes open and support inbound calling functionality from the Internet, a statistical profile of the network conditions can be acquired.

For example, in order to accurately measure jitter, multiple measures are required of the latency between the outgoing message transmitted from the server and the corresponding receipt of the confirmation message from the device. If the message from the server to the client times out and retransmission is required, this generally indicates that a packet has been lost, although it could indicate that the network delay has increased to very high levels. An example of the measurement of network delay using standard REGISTER messages between the device and the server is shown below, according to the SIP protocol, although other protocols such as Inter-Asterisk eXchange (IAX), International Telecommunications Union (ITU) H.323, or even proprietary protocols could be utilized.

Below is an example of standard SIP REGISTER messages that are sent from the device to the proxy server, with the corresponding time stamps of messages to calculate the underlying network delay.

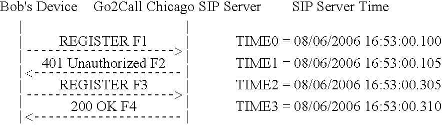

For this example, the user Bob is on an IP phone operated by the service Go2Call. The Media Access Control (MAC) address of Bob's device is a hexadecimal number 001122DDEEFF. The MAC address scheme is designed to provide a globally-unique layer-2 address for any device. The service provider implements the name Go2Call.com as the primary and top level domains for Go2Call's globally distributed SIP proxies. By utilizing the present methods and systems, Go2Call has specifically configured Bob's device so that the host name of the Go2Call's proxy server in Bob's device is 001122DDEEFF.go2call.com, where 001122DDEEFF is the subdomain, go2call is the primary domain, and .com is the top-level domain.

Note that this is different from server domain names currently implemented by ITSPs, which would traditionally configure Bob's device so that the domain name of the proxy would be associated with the server, such as “chicago.go2call.com” or “proxy1.go2call.com”. Although the MAC address is utilized to create a host name specific to Bob's device in the subdomain, the ITSP could implement other naming mechanisms in order to specify a host name specific to the Bob's device. Other naming conventions for the subdomain include the telephone number, an algorithmic hash of Bob's user name and password, a form of Bob's e-mail address, a form of the public IP address associates with Bob's device, or a serial number of the device.

Bob's IP phone is at an unknown geographical location, but his IP phone is connected behind a NAT somewhere on the public Internet. Go2Call has multiple proxy servers around the world and would like to specify the server with the best network conditions for VoIP service between the server and Bob. The benefits of specifying the proxy with a device-specific host name associated with Bob's device will be highlighted below. With regular SIP messaging, Bob's device sends a first registration request, but Go2Call's proxy server needs to authenticate the registration, and thus issues a challenge in the form of a nonce in the 401 unauthorized message. Bob in turn registers again with an MD5 hash of his password and the nonce, thus allowing the Go2Call.com proxy to securely authenticate Bob. The time stamps shown above with each message are the time when the server completes the processing of each message.

TIME2 less TIME1 is the sum of the delay for transmission of messages across the Internet and the time required to process the messages on the user device and server. For networks with meaningful delay for a VoIP call, and both servers and devices with sufficient available processing power, TIME2 less TIME1 corresponds to a useful approximation of the inherent network delay. In addition, TIME2 less TIME1 is especially useful for comparing the network delay between any two servers and a user device, because the difference between TIME2-less-TIME1 values at each server will represent the underlying network delay, assuming the processor speeds and server loads are the same for both servers and the time to process messages on the device does not change.

Specifically, in the above example, TIME2 less TIME1 is 200 milliseconds. If the 401 Unauthorized message is not responded to within a sufficiently large timeout value, such as 5000 milliseconds, and a retransmission is required, this indicates the packet is likely lost and the loss of the packet can be also be recorded on the server. By specifying the registration interval at a sufficiently short period, such as 60 seconds, Bob's device is configured to frequently send REGISTER messages to the server in order to keep the NAT pinhole open. Such techniques for supporting user devices behind NATs are well known in the art.

Over the course of 30 minutes, the server can record a statistical profile of 30 samples of the network delay between Bob's device and the server. For example, if 2 of the messages timeout, and the standard deviation in delay is 50 ms, and the average of the remaining 28 samples of TIME2 less TIME1 is 200 ms, and the combined processing time for both the user device and server of each successful REGISTER request is estimated to be 20 ms, Go2Call.com has a useful estimate of the network delay. In this example, the jitter is 50 ms, the network delay is 180 ms, and the packet loss is 2/30 or 6.67%. In addition, the repeated messages between the server and user device may be analyzed to determine other measures of network quality that may be important for the ITSP such as the frequency of bit errors or out-of-order packets.

In the current example, the domain 001122DDEEFF.go2call.com corresponds to Go2Call's proxy in Chicago, at the IP address 216.52.153.222. Go2Call has multiple servers distributed around the world, and wants to select the server with the best network conditions between Bob's device and Go2Call's servers. For example, Go2Call may also have a proxy server located in the London. By specifying the host name of Go2Call's proxy to be associated with Bob's device, Go2Call can selectively change the proxy for Bob's device by changing the IP address of the DNS record for the host name, without impacting other user devices that are connected to Go2Call's network. If the IP address of Go2Call's proxy in the London is 85.31.53.111, Go2Call can change the resolution of the DNS record for the host name 001122DDEEFF.go2call.com from the IP address 216.52.153.222 to the IP address 85.31.53.111. Although IPv4 addresses are shown, other packet-switched addresses and routing mechanisms could be implemented, such as IPv6 with 128 bit addresses, token ring, or DECnet.

The Domain Name Service includes standard parameters for the timeout value for the validity of the DNS record, known as “time to live”. Go2Call can specify the timeout value to be sufficiently small, such as 30 minutes, so that Bob's device will obtain the new IP address for the name 001122DDEEFF.go2call.com after the timeout value has transpired, such as 30 minutes. As soon as Go2Call begins receiving Bob's first registration requests at 216.52.153.222 in Chicago, Go2Call can change the IP address of the DNS record for the host name 001122DDEEFF.go2call.com to 85.31.53.111 in order to subsequently also obtain the network quality between Bob's device and Go2Call's server in London at 85.31.53.111. Thus, 30 minutes after Bob's device initially began registering with the IP address 216.52.153.222, Bob will begin registering with 85.31.53.111, even though the proxy name 001122DDEEFF.go2call.com in the configuration of Bob's device is unchanged, and the change in proxy servers for Bob's device affected no other devices on Go2Call's network.

Further, the change in proxy utilized by Bob's device did not require download of a new device configuration file onto the device. If the ITSP used traditional methods for changing the proxy in Bob's device where the host name of the proxy is associated with the server, the proxy field in the device configuration would have to be updated from chicago.go2call.com to london.go2call.com. Thus, by changing the resolution of the DNS record for the host name of the proxy associated with Bob's device, the ITSP can change the server Bob registers with, and no modifications of Bob's device configuration are required. By changing the resolution of the DNS name to Go2Call's London proxy server at 85.31.53.111, Go2Call can acquire a second statistical set of network quality measures between Bob's device and the second server at 85.31.53.111. Below is a representation of the new time values in London, upon change of the IP address for the host name for the proxy server on Bob's device:

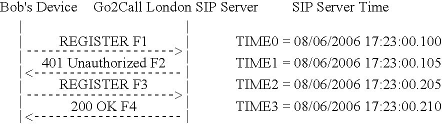

After change of the resolution of the DNS name 001122DDEEFF.go2call.com, and after 30 minutes with 30 additional registration requests, Go2Call determines that 1 of the messages timed out, the standard deviation in delay is 25 ms, and the average of the remaining 29 samples of TIME2 less TIME1 is 100 ms. Go2Call can assume the server and device processing speed are the same as the prior example where Bob registered with the proxy server in Chicago, so combined processing time for both the user device and server of each successful REGISTER request is again estimated to be 20 ms. In this second example, the jitter is 25 ms, the network delay is 80 ms, and the packet loss is 1/30 or 3.33%. By altering the IP address for the resolution of the host name for the DNS record for 001122DDEEFF.go2call.com and recording statistical samples of the time stamps of messages on the server, Go2Call can compare the network quality between Bob's specific device and the two proxy servers in Chicago and London.

The present method of altering the resolution of the host name via expiration of specified DNS “time to live” parameters can be repeated until the server with the optimal network conditions can be found between Bob's device and Go2Call's globally-distributed proxy servers. Thus, Go2Call can find the server best suited to serve Bob's user device even though Bob is at an unknown geographical location connected to an ISP with unknown rules for routing Internet traffic. After an initial proxy server is selected for the user device, each message from the server requiring a response message to be sent back to the server can be used to measure the connection quality.

Many devices are connected 24 hours a day, and measurements of network quality can be continuous and adjustments can be made during the network's least-busy hours of the day. Alternatively, measurements of network quality can be made during peak hours, preferably when the user device is idle. Although SIP messages are shown, any VoIP protocol with required confirmation messages between the server and the client can be used. For example, the IAX2 protocol utilizes full frames for signaling messages, including registrations. The time between a full frame message issued from the server and the response from the client can be recorded to determine network delay, as well as recording if retransmission was required, indicating packet loss.

Since the domain name of the proxy is associated with Bob's device, the optimal routing unique for Bob's device can be obtained and implemented, without impacting any other user devices on Go2Call's network, since no other device utilizing Go2Call's network specifies a proxy with the host name 001122DDEEFF.go2call.com. In addition, Bob's device can implement any VoIP standard such as SIP, IAX, H.323, or XMPP, and does not require customized programming on the device in order for the ITSP to specify the server with the optimal network conditions specifically for Bob's device.

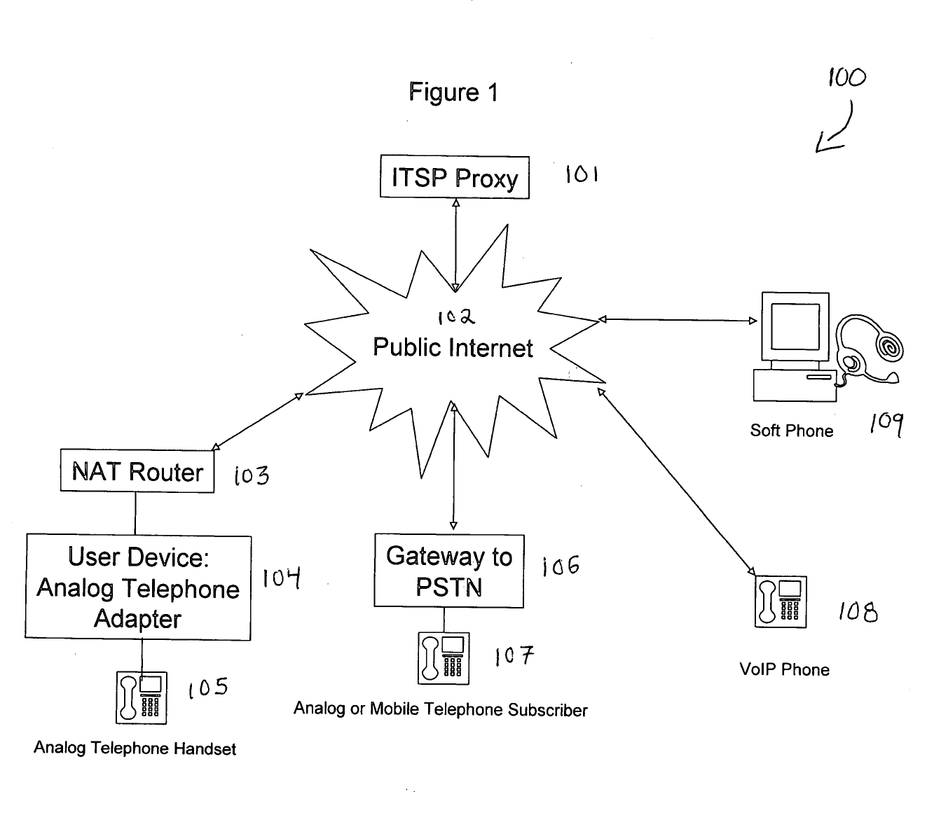

### 1. FIG. 1

FIG. 1 is a graphical illustration of an exemplary VoIP system 100. The system 100 includes a user device 104 from which a user wishes to place or receive a call to other users accessible either through the Internet or the PSTN. The user device 104 most commonly connects to the Internet via a NAT router 103, although the user device could also bypass the NAT router and access the Internet directly. An ITSP operates a proxy 101 to communicate calls originating from the Internet to the user device, such as a call to the telephone number assigned to the user device. In addition, the proxy 101 will accept calls originating from the user device destined for other users accessible through the public Internet 102. The proxy 101 can be any server on the ITSP's network that communicates call control requests or media between the user device 104 and other user devices or servers on the Internet.

Other user devices for communicating voice or video can be called from the user device through multiple access methods. The ITSP or other Internet telephony service provider may operate a telephone gateway 106 to the public switched telephone network (PSTN) between the public Internet 102 and the PSTN, which provides service to a landline or mobile telephone 107. The ITSP may operate its own gateway 106 to the PSTN, or operate multiple gateways distributed in different geographical locations. Alternatively, the ITSP can send calls from a user device 105 to the landline or mobile telephone 107 through a gateway owned and operated by a third party wholesale call termination service such as iBasis, Teleglobe, or Arbinet. Although a gateway is shown in order to communicate calls between the PSTN and Internet, the gateway can optionally be omitted if calling between the user device 105 and the landline or mobile telephone 107 is not required.

Other users can also be accessed through a VoIP Phone 108 that is connected to the Internet or a soft phone running on a computer 109. The user devices 108 and 109 communicate voice or video traffic by taking the analog signal input into the user device, digitizing and compressing the signal with a codec, and transmitting the media in packets to the other device(s) participating in a call. The public Internet 102 includes network equipment that routes the individual packets containing media and call control to a destination address identified in the individual packets. The sampling rate for audio is preferably chosen to be high enough to sound like a continuous voice signal to the human ear, or a video sampling rate is preferably chosen to be high enough to appear like a continuous moving image to the human eye.

Many different protocols can be used for communicating call control and media across the ITSP's network shown in FIG. 1. The user device 104 may implement industry standard call control and signaling such as SIP, H.323, IAX, the Extensible Messaging and Presence Protocol (XMPP), the Media Gateway Control Protocol (MGCP), and/or proprietary protocols in order for end users to place and receive voice and video calls. Voice and video media can be communicated according to several different codecs, such as G.711, G.723.1, G.729, iLBC, ADPCM for voice communications or MPEG3, MPEG4, H.261 or H.263 for video communications, as examples.

Although the user device 104 is shown as being a single device in FIG. 1, an ITSP may have several or many user devices similar to the user device 104. Likewise, although the proxy 101 is shown as being a single proxy, the ITSP may have several or many proxies similar to the proxy 101. Different user devices would likely be distributed in various geographical regions supported by the ITSP, and the proxies may also be distributed in various locations around the world in order to provide a robust network with minimal network delay between the proxies and the user devices. Although a single NAT router 103 is shown, the user and ISP may have multiple NAT routers between the user device 104 and the public Internet 102.

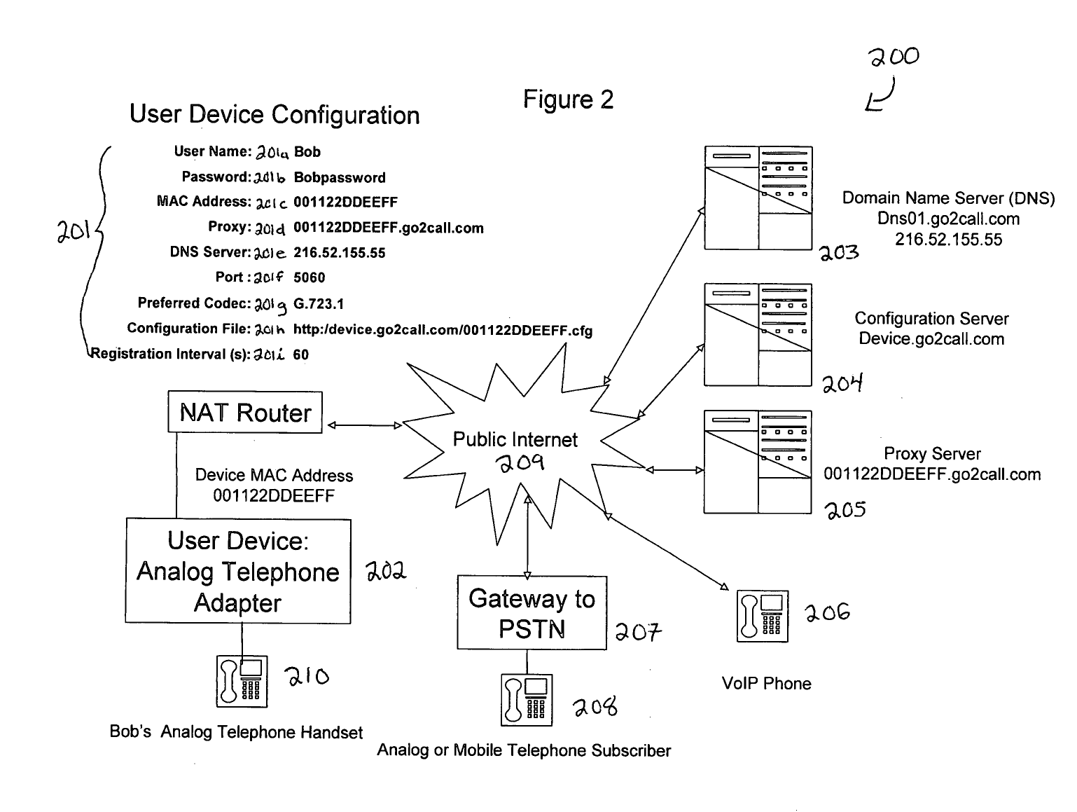

### 2. FIG. 2

FIG. 2 is a graphical illustration of a system 200 for configuring a user device for communicating with an ITSP's network, including the use of a device-specific host name for the proxy associated with the user device. The user device 202 generally requires configuration parameters in order to establish communication with the ITSP's proxy server 205. The configuration is provided in the form of a user device configuration file 201 that is downloaded from the configuration server 204 upon powering on or rebooting the user device 202. Once the configuration file is downloaded to the user device and applied to the device's running configuration, the user device can contact the ITSP proxy server 205 and begin placing or receiving calls with other devices such as the VoIP phone 206 or the gateway 207 to the PSTN to call a landline or mobile telephone 208.

The user device configuration file 201 includes several parameters required to establish communication with the ITSP proxy server 205. Parameters may include the user name 201a, password 201b, device MAC address 201c, proxy host name 201d, DNS server 201e, Internet protocol port number 201f, codec 201g, file path for the user device configuration file on the configuration server 201h, device registration interval 201i, etc. The user name 201a and password 201b are used to authenticate messages between user device 202 and proxy server 205.

The MAC address 201c is the globally-unique layer-2 identifier to specify the device, and the MAC address is used to create a unique file path or name for the user device configuration file 201 on the configuration server 204. The proxy server host name 201d specified in the device configuration file 201 is the proxy server for the user device to send registration and other call control information. In a preferred embodiment, the host name of the proxy server is unique to the device, and the globally-unique MAC address is used to create the device-specific proxy host name, although other unique identifiers could be implemented by the ITSP, such as a hash function of the user name and password, telephone number for the device, e-mail address, etc.

In addition, the device host name does not have to be unique to the device in order to be associated with the device. For example, a group of devices may all access the Internet from the same Class C IP address range, such as 216.52.55.*, where * represents any number from 0 through 255. The ITSP could assign a host name such as “216-52-55.go2call.com”, and specify the proxy server for the host name for the group of devices connecting to the Internet through that Class C range of public IP addresses. In this example, the domain name is still associated with the device, as opposed to being associated with the ITSP's proxy servers.

Other groupings of IP addresses such as the IPv4 Class B address range or IP address subnets could be utilized to create host names for the proxy that is associated with the user device. Another useful example is assigning a domain name associated with the device based upon the postal code in which the device resides. For example, if the device belongs to an end user in the US zip code 60201, the host name of the proxy for the device could be 60201.go2call.com. Thus, a domain name can be associated with a device even though it is not unique to the device. For an ITSP network in commercial production with thousands or more devices and dozens or more servers, implementing host names associated with the user devices will create and utilize many more host names for proxy servers than the number of physical proxy servers.

The benefit of utilizing the same name across a range of devices is the measurements of network quality from the proxy server to all devices within the same Class C IP address range will likely be highly correlated. One drawback is that the Class C IP address utilized by the device may not be known before the device is connected to the Internet, and the Class C IP address of the device may change, if the user moves the device or if the ISP dynamically assigns IP addresses to the NAT router or the device.

The Domain Name Server (DNS) for the device is specified in the DNS server field 201e. This allows the user device 202 to query DNS records at the IP address of the ITSP Domain Name Server 203. When the device sends packets to the proxy server 205, the proxy host name 201d should be resolved into an IP address in order for the IP packets to be routed through the public Internet 209. As is well known in the art, the user device 202 converts the proxy host name 201d into an IP address used in the header of outgoing packets.

Although the IP address of the DNS server 201e is shown to be the ITSP DNS server 203 in a preferred embodiment, other DNS servers could be specified, such as the DNS server of the ISP providing Internet connectivity to the user device 202. In this case, changes for the IP address of the proxy host name will be propagated across the public Internet 209 according to the global Domain Name System. Although one proxy host name is implemented in the device configuration field 201d, multiple host names could be implemented, and multiple host names are often supported by vendors of user devices. One host name could serve as the primary proxy, and other host names could serve as secondary or backup host names if connectivity is lost with the primary proxy server. If multiple host names are implemented on the device, the ITSP could use a different host name associated with the device for each proxy field, such as “MAC Address”1.go2call.com, “MAC Address”2.go2call.com, etc.

The port number 201f specifies the port of the proxy server 205 to which the proxy server listens for receiving and transmitting messages to the user device 202. In a preferred embodiment, the well known SIP call-control port 5060 is utilized by the proxy. The preferred codec 201g specifies the preferred codec the device implements for compressing voice or video data for transmission across the public Internet 209. Although a single codec is listed, the user device 202 may implement multiple voice and/or video codecs, and present the list of codecs in an order of preference when communicating through the proxy server 205 with the other user device 206 or the gateway to the PSTN 207.

The configuration server and file 201h specifies the location of the server and file path that the user device 202 accesses to obtain the user device configuration file 201. In a preferred embodiment, the configuration server and file 201h is specified as located on the configuration server 204 operated by the ITSP. The specification of the configuration server and file 201h as the location for the User Device Configuration file 201 may be established in the device's base configuration, such as when the device is manufactured, when the device is shipped from the ITSP to the end user, or when a technician or end user installs the user device 202 at the end user's home or office.

By specifying the configuration server and file 201h in the base configuration before other parameters such as user name and password are specified or are even known to the ITSP, the user device can download the device configuration file 201. The registration interval 201i specifies the frequency the device registers with the proxy server 205. In a preferred embodiment, this registration interval is set to a sufficiently short duration to keep the NAT pinhole open, so that call-control messages from the proxy server 205 can reach the user device 202, and an incoming call to the user device from the public Internet 209 can be established.

Other parameters may be included, depending on the manufacturer of the device and the Internet telephony protocol implemented, such as SIP, IAX, H.323, or XMPP. For example, an outbound proxy may be specified to support the traversal of SIP messages through a NAT, and a host name associated with the device similar to the proxy host name 201d can also be specified as the outbound proxy. In addition, the ITSP may select not to specify all of the listed parameters. For example, if authentication is not required, then the ITSP can omit the password or specify a password that is not unique to the device or end user such as “password”.

Although a single device, DNS server, configuration server, proxy server, and gateway to the PSTN are shown in FIG. 2, the ITSP may have multiple user devices, DNS servers, configuration servers, proxy servers, and gateways to the PSTN. The servers and gateways may be distributed geographically. In addition, multiple servers and gateways allows the ITSP to scale the network to support up to millions of user devices distributed either in a specific region of the world or distributed worldwide. Although the user device shown is an analog telephone adapter (ATA) connected to an analog telephone handset 210, the user device could be any internet telephony capable device such as a mobile phone, a VoIP phone, a soft phone running on a personal computer, a video phone, etc. Furthermore, the VoIP phone 206 may be serviced by a second ITSP with its own proxy server and network, and calls between the two ITSP proxy servers may be required to establish calls between the user device 202 and the VoIP phone 206.

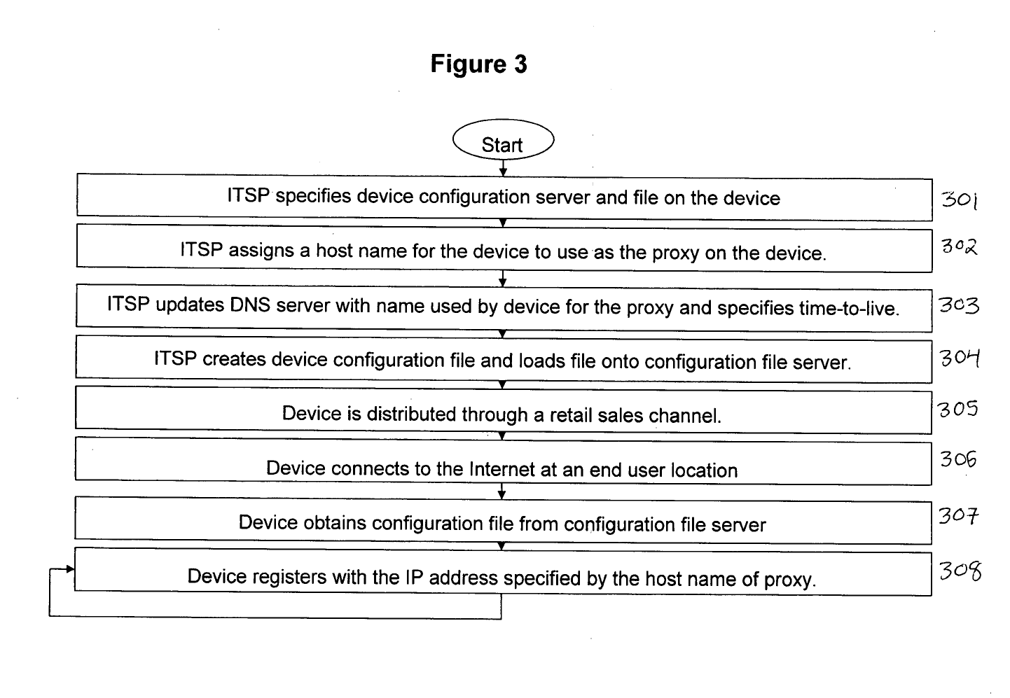

### 3. FIG. 3

FIG. 3 is a preferred flow sequence for assigning to the device 202 a host name associated with the device 202 as its proxy. The ITSP may need to perform a series of steps to properly configure the user device 202 and begin registrations from the device 202 to the proxy server 205, thereby connecting the device 202 to the ITSP's network. When the ITSP or the ITSP's commercial partners procures the device 202 from the manufacturer, the device configuration server 204 and file 201h are specified on the device 202 at 301. The device configuration server 204 and file 201h may be required to automatically configure the device 202 when it is connected to the Internet for the first time.

At 302, the ITSP assigns a host name for the device 202 to use as the proxy. In a preferred embodiment, the host name is unique to the device 202, and incorporates a unique identifier such as the MAC address of the device 202, although other unique identifiers such as telephone number could be used. At 303, the ITSP updates its DNS server 203 with a DNS record for the host name assigned to the device 202 for the device's proxy 201d and specifies the time-to-live of the DNS record. The time-to-live parameter specifies the duration the DNS record will be valid on the global DNS system. The time-to-live parameter thus specifies the duration the device 202 will store the IP address of the device-specific proxy server 205, and the ITSP can adjust the frequency of DNS queries by adjusting the time-to-live parameter in the DNS record. In a preferred embodiment, the ITSP sets the time-to-live parameter to 30 minutes.

At 304, the ITSP creates the device configuration file 201 and loads the file onto the configuration server 204 in the file path specified by 201h. At 305, the device 202 is delivered to the end user through a retail sales channel. At 306, after the device 202 is delivered to the end user, the device 202 is connected to the Internet through the end user's ISP connection, and the Internet connection could be ADSL, ISDN, wireless, leased line, or any other type.

At 307, upon connection to the Internet, the device 202 downloads the user device configuration file 201 from the configuration server 204. At 308, the device 202 implements the configuration file, obtains the DNS record for the host name, and begins registering. Step 308 is shown as a continuous process, as the registration of the device 202 with the proxy server 205 will continue until the device 202 is turned off, the Internet connection is lost, or the end user discontinues the service with the ITSP.

Although other sequences of actions can be taken by the ITSP to configure the device, each of the above-described steps in FIG. 3 is required in a preferred embodiment. For example, the creation of the device configuration file in 304 can be implemented before the ITSP updates the DNS server 203 with the host name used by the device 202 for the proxy in 303.

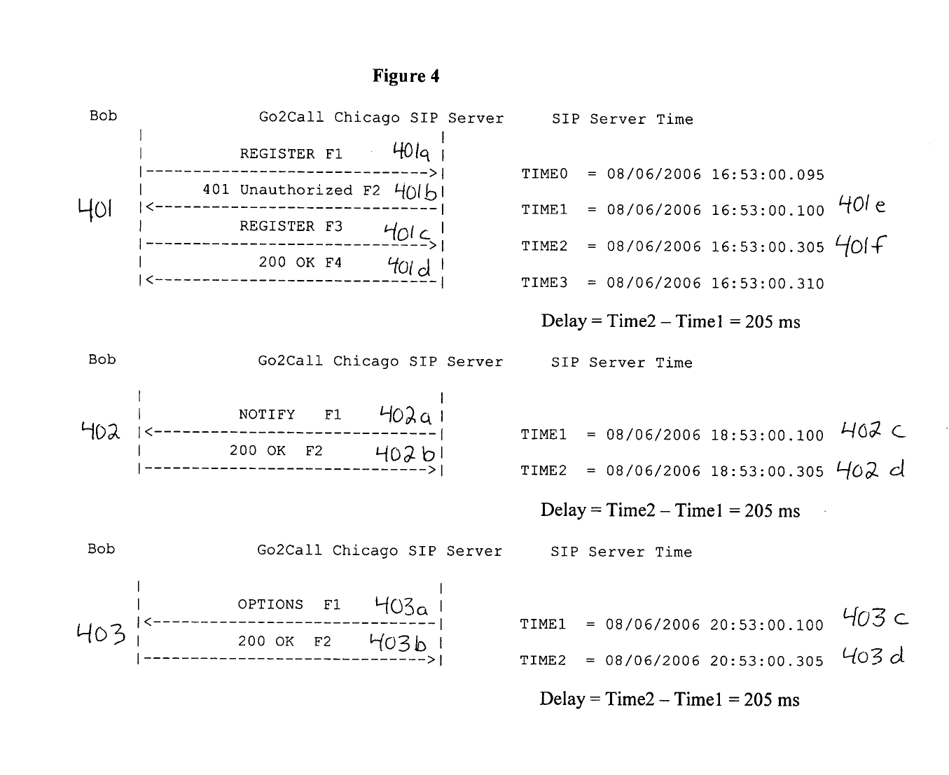

### 4. FIG. 4

FIG. 4 is a simplified message flow diagram illustrating confirmed messages from the server to the user device with the recorded timestamps to measure network delay. During the normal operation of a user device and proxy server, messages are transmitted between the user device and proxy server in order to maintain communication and support both inbound calls to the user device and outbound calls from the user device. Time stamps of the messages are recorded on the server, in order to measure the delay. In a preferred embodiment, the message frequency is sufficient to keep NAT pinholes open between the user device and the ITSP proxy.

Message flow 401 shows the messages between the user device and proxy server for secure communication using the SIP protocol. The user device issues a REGISTER request 401a to the proxy server, and the message is received by the proxy server at TIME0. With secure SIP or any other secure internet telephony protocol, the proxy server issues a “401 Unauthorized” or similar response 401b with a challenge in the message, such as a nonce. The time stamp 401e, corresponding to when the challenge is sent by the proxy server, is recorded on the proxy server at TIME1. The user device sends a second REGISTER request 401c with a response to the challenge from the proxy server, and upon receipt of the second REGISTER request 401c at the proxy server, the proxy server records the time TIME2 401f.

With a successful second REGISTER request 401c, the proxy server issues a “200 OK” message, notifying the user device that the second REGISTER request 401c was successful. The calculated delay is TIME2 less TIME1, and corresponds to the network delay plus the delay required for the server and device to process messages “401 Unauthorized” 401b and the second REGISTER 401c. For a network with delay that is meaningful for the underlying voice quality, and with sufficient processing power on both the proxy server and user device, TIME2 less TIME1 provides a useful estimate of the underlying network delay. If TIME2 less TIME1 is recorded on a different proxy server to the same user device, the comparison of TIME2 less TIME1 from the different proxy servers will provide a direct comparison of the network delay, assuming the processing power and load on the two proxy servers is similar.

In order to obtain the measure of TIME2 less TIME1, any message from the server to the device that requires confirmation back to the server can be utilized to measure delay. Message flow 402 illustrates a SIP NOTIFY message 402a sent from the proxy server at TIME1 402c, with the corresponding “200 OK” response 402b from the device received at the proxy server at TIME2 402d. The NOTIFY message can contain parameters such as specifying if the ITSP has a voicemail message waiting. Message flow 403 illustrates a SIP OPTIONS message 403a sent from the proxy server at TIMES 403c, with the corresponding “200 OK” response 403b from the device received at the proxy server at TIME2 403d. The OPTIONS message can be used by the proxy server to obtain the capabilities of the user device, such as a list of supported codecs.

Message flows 402 and 403 can be utilized by the ITSP to initiate messages from the proxy server and measure network delay at intervals other than the regular registration interval from the user device. In addition, message flows 402 and 403 can be utilized by the ITSP to keep the NAT ports open. Although SIP messages are illustrated in FIG. 4, other protocols could be utilized that implement messages from the server to the user device that require confirmation of receipt back to the server, or simply any response to the server. For example, the IAX REGISTER message could be used instead of SIP REGISTER, if both the user device and proxy server support IAX, or a proprietary protocol could be implemented if both the user device and proxy server implement the protocol. The measurement of TIME1 and TIME2 can be obtained through any message sent from the server to the user device, wherein the user device responds back to the server.

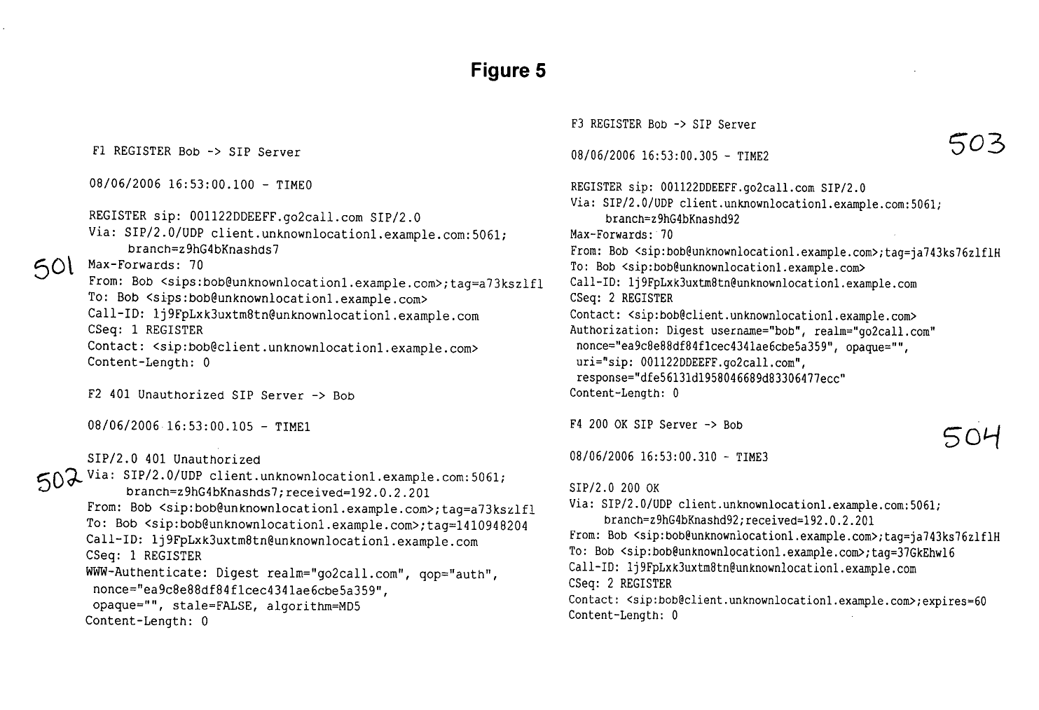

### 5. FIG. 5

FIG. 5 is an exemplary embodiment of the message flow and time stamps between the server and the user device for a preferred sequence of messages consisting of a registration request, a “401 Unauthorized” challenge, and a second registration request in response to the challenge. Once the user device 202 of the system 200 has obtained the device configuration file according to the steps in FIG. 3, the device will begin the registration process. A REGISTER request 501 is received at the proxy server at TIME0.

The device has implemented the host name specified in the device configuration file. The host name is the server that receives the REGISTER request 501, as shown in the REGISTER field of the SIP message. In a preferred embodiment, the host name includes the MAC address of the device as the subdomain and the ITSP as the primary domain. With a MAC address of 001122DDEEFF and the ITSP primary domain of go2call.com, the host name of the proxy on the device is 001122DDEEFF.go2call.com. Although user datagram protocol (UDP) is shown as the transport protocol in message flow 500, other transport protocols such as transmission control protocol (TCP) or transport layer security (TLS) could be used.

The secure response to the REGISTER request 501 is a “401 Unauthorized” response 502 with a challenge in the form of a random nonce. In a preferred embodiment, the ITSP implements secure SIP on its network, in order to ensure end users are properly authenticated and confirm the identity of end user devices. In secure SIP across the public Internet, the ITSP will not accept an unchallenged REGISTER request, since the user must be securely authenticated. The “401 Unauthorized” response provides the challenge to securely authenticate the user device through the use of a random nonce in response 502. The time stamp the proxy server issues the “401 Unauthorized” response is recorded at TIME1.

Upon receipt of the “401 Unauthorized” response from the proxy server, the user device issues a second REGISTER request 503. The user device is again sending the REGISTER request 503 to the host name specified for the device, which is “001122DDEEFF.go2call.com”. All messages sent from the device to the ITSP proxy will implement this device-specific host name for the proxy in a preferred embodiment. Other devices may register with the same proxy, but will implement a different host name in a preferred embodiment. The time the server processes the second REGISTER request 503 is recorded as TIME2. The request 503 includes a response field in the message, which contains a secure hash function of the user name, user password, and nonce issued in response 502. The proxy server can then securely authenticate the user device through the secure hash function, and issues a “200 OK” response at TIME3.

In a preferred embodiment, the message flow 500 is repeated approximately once every minute, to keep the NAT pinhole open, so that incoming messages such as a SIP INVITE to the user device from the proxy server can be received by the user device. The majority of NAT devices in commercial use may not be “SIP aware” and allow messages to transmit from the public Internet to the user device only if the NAT pinhole is kept open, and thus frequent REGISTER messages 501 from the device to the proxy server are required, with the corresponding “401 Unauthorized” response 502 for each REGISTER request 501.

The authentication scheme outlined in FIG. 5 is implemented widely across many vendors of user devices, and thus the ITSP can easily determine the network delay to each device by recording TIME1 and TIME2 on the proxy server in a preferred embodiment. Consequently, proprietary messages or programming on the user device is not required to measure the round-trip network delay between the proxy server and the user device, providing the ITSP the commercial benefit of native support of a wide range of user devices in a preferred embodiment. Although FIG. 5 outlines SIP REGISTER messages, other protocols and messages could be utilized. TIME1 and TIME2 could be measured by the ITSP for any message sent from the server to the user device, where the device responds back to the server.

The message flow outlined in FIG. 5, or similar messages from the server to the client may be useful for measuring other network quality parameters such as bit errors. For example, the ITSP may serve devices over a wireless network, where determining the level of bit errors during radio transmission is more important to monitor quality, compared with traditional land-line Internet access such as ADSL or leased-line. By using methods well known in the art such as UDP or TCP checksums, or analyzing the packet contents for errors, the ITSP can also obtain a measure of bit errors through the network. The bit error rates between the user devices and proxy servers can be utilized by the ITSP in optimizing the selection of a server with optimal network quality for the user device.

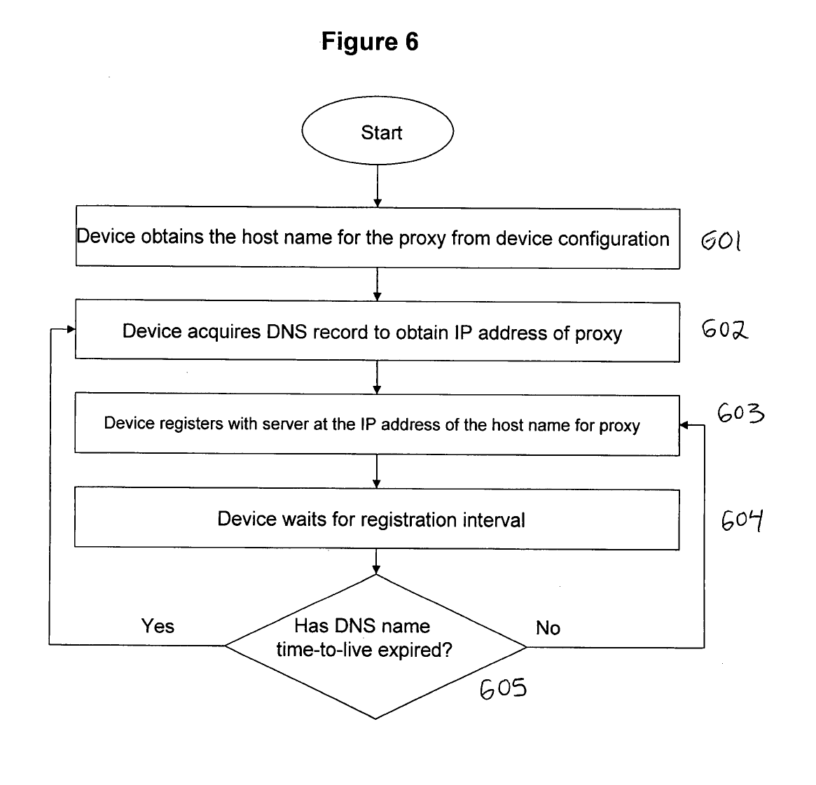

### 6. FIG. 6

FIG. 6 is a simplified block diagram illustrating the device registration process utilizing the host name and DNS record and time-to-live values associated with the device. By implementing a device-specific host name as the proxy server on the user device, the ITSP can select different proxy servers for the device by changing the DNS record for the host name.

Immediately after startup of the device, at 601, the user device obtains the host name of the proxy for the device from the device configuration file. Before registration with the ITSP proxy can begin, the user device must access the DNS record of the host name through the global DNS system. At 602, the device acquires the DNS record of the host name, which resolves the host name into a specific IP address of the ITSP proxy. The device will utilize this IP address as the destination address in outgoing messages to the proxy, so the public Internet can route the packets to the ITSP proxy.

At 603, the device registers with the proxy specified by the IP address in the DNS record for the host name. At 604, after registration, the device waits a specified time before attempting subsequent registrations. In a preferred embodiment, the registration interval is set to be sufficiently short, to keep NAT pinholes open, such as a registration interval of one minute.

At 605, upon expiration of the registration interval, the device determines if the time-to-live value of the DNS record for the host name has expired. The time-to-live value for the DNS record is set by the ITSP, and in a preferred embodiment the time-to-live value is set at approximately 30 minutes. The time-to-live value can be adjusted by the ITSP according to the frequency the DNS record should be accessed by the device and the expected frequency of changes in the IP address of the proxy server for the specific device.

If the time-to-live has expired, the device returns to step 602 to acquire the DNS record for the host name. This allows the ITSP to implement a change in the IP address of the host name used by the device as the proxy server, via a subsequent query of the DNS record. If the time-to-live has not expired, the device returns to step 603 and registers again with the IP address of the proxy server specified by the device's previous query of the DNS record. In order to maintain continuous communication between the proxy and the device, the device registration process outlined in FIG. 6 would continue until the device is turned off, the Internet connection is lost, or the end user no longer subscribes to the service provided by the ITSP, as examples.

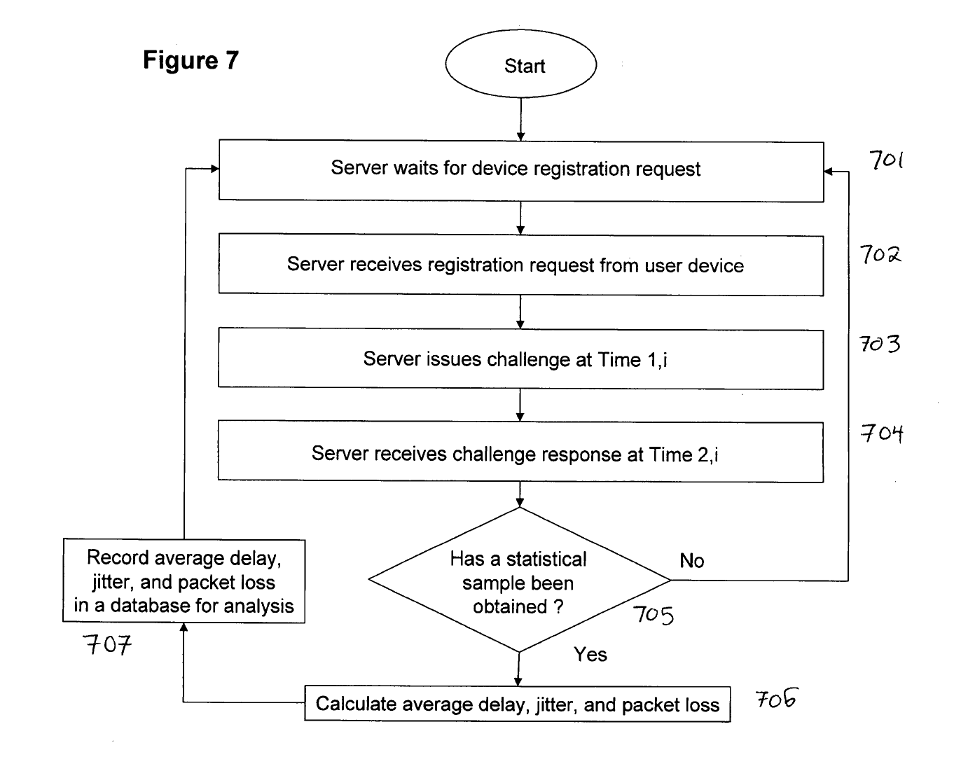

### 7. FIG. 7

FIG. 7 is a simplified block diagram illustrating an exemplary embodiment measuring the network delay between a user device and a proxy through a challenge and response. In order to select the optimized routing from a user device to the ITSP's network of proxy servers, the ITSP needs statistical measures of the network quality between the user device and various proxy servers. Selecting a proxy server with a superior network connection to the user device requires a statistically valid comparison of the network quality between the device and each proxy server. Measurements of jitter require multiple measurements of delay, and jitter is well known in the art to affect the quality of media in real-time communication such as voice or video data.

At 701, the proxy server waits to receive a registration request from the user device. Upon receipt of the registration request at 702, the server will initially not accept the registration request, since the user device must be authorized in order to maintain a secure network and prevent unauthorized users from accessing the proxy server and corresponding ITSP network. At 703, the server issues a challenge response to the registration request at TIME1,i, where i represents a counter of the number of times the user device has registered with the proxy server, and TIME1,i is recorded on the proxy server. At 704 at TIME2,i, the proxy server receives a response from the user device to the challenge issued at 703.

At 705, the proxy server determines if a statistical sample of the network delay has been acquired through repeated registration requests. In a preferred embodiment, the number of samples of network delay to obtain a statistical measure of network quality is 30 samples, which would correspond to approximately 30 minutes of registration if the user device registers once per minute. If a statistical sample of the network delay has not been acquired, the process returns to 701, where the proxy server waits for the next registration request. If a statistical sample has been acquired, at 706, the proxy server calculates the average delay, jitter, and packet loss, and the data is recorded in a database for analysis by the ITSP at 707, and the process returns to 701.

Jitter is a measure of variation in delay, and can be estimated by the standard deviation in multiple measures of delay. If the user device fails to issue a response to the challenge within a specified timeout value, the packet can be recorded as lost, providing another important measure of the network quality between the device and the proxy server. In a preferred embodiment, the timeout value for the user device to respond to the challenge is 5000 milliseconds, and if no response from the device is received during that period, the packet is considered lost. By recording the average delay, jitter, and packet loss in a database, the ITSP can subsequently perform an analysis of the network quality between the user device and the proxy, such as comparing the quality of the different network connections on the public Internet between the user device and different proxy servers operated by the ITSP.

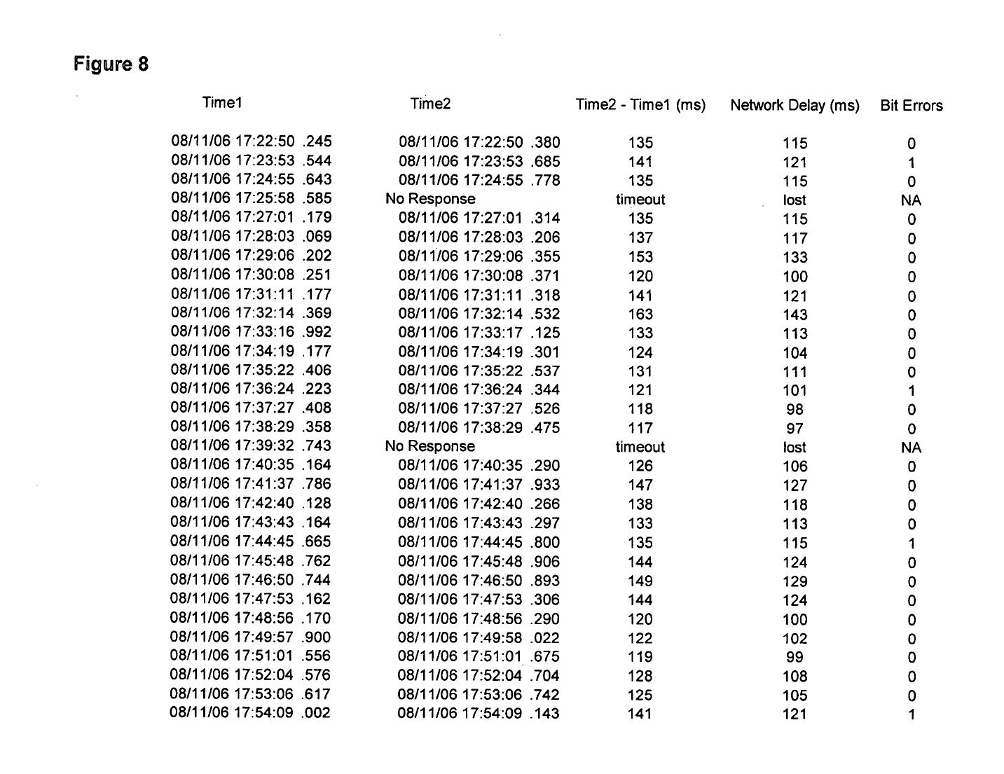

### 8. FIG. 8

FIG. 8 is a simplified tabular summary illustrating multiple network delay measurements between a user device and a proxy. In order to acquire statistical measures of the network quality between a user device and a proxy, multiple measurements of the delay are required, and FIG. 8 illustrates example data according to a preferred embodiment. TIME1 corresponds to the server time when the proxy server issues a challenge to a registration request from the user device. TIME2 corresponds to the server time when the proxy server receives a response from the user device for the challenge. No response value for TIME2 indicates the challenge response was not received within a specified timeout value, such as 5000 milliseconds, thus indicating the packet was lost.

TIME2−TIME1 is a measure of the network delay plus the processing time required on the server and the user device to process the challenge and the user device response. Network delay is calculated based upon an estimate of the time required to process the challenge and response on the server and user device. In this example, the processing time is estimated to be 20 milliseconds, and is approximated to be a fixed value. Thus, the inherent network delay is TIME2−TIME 1, less 20 milliseconds. The user device registers approximately every minute in order to keep the NAT pinhole open, keeping the bindings for the ports open on the NAT and allowing continuous communication from the proxy server to the user device.

With the example data presented in FIG. 8, the ITSP can calculate the average delay, jitter, and packet loss on the public Internet between the user device and the proxy server. In this example, the average delay is 113.6 milliseconds, the jitter, or standard deviation of delay, is 11.5 milliseconds, and the packet loss is 2/30 or 6.67%. Although 30 samples of network delay are shown in FIG. 8, the ITSP could acquire a statistically valid sample of data based on other sample sizes, such as 10 samples or 100. In addition, the registration interval could be set to a different value than 1 minute, such as 30 seconds or 90 seconds. Although TIME1 and TIME2 are recorded for issuing a challenge and receiving a response, respectively, TIME1 and TIME2 could be recorded for the time any message is sent by the server and the time the server receives a reply, respectively.

FIG. 8 also includes a calculation of the number of bit errors observed in the messages. An overall estimate of the bit error rate can be calculated and included in the ITSP in selecting a server for the user device with the overall highest quality network.

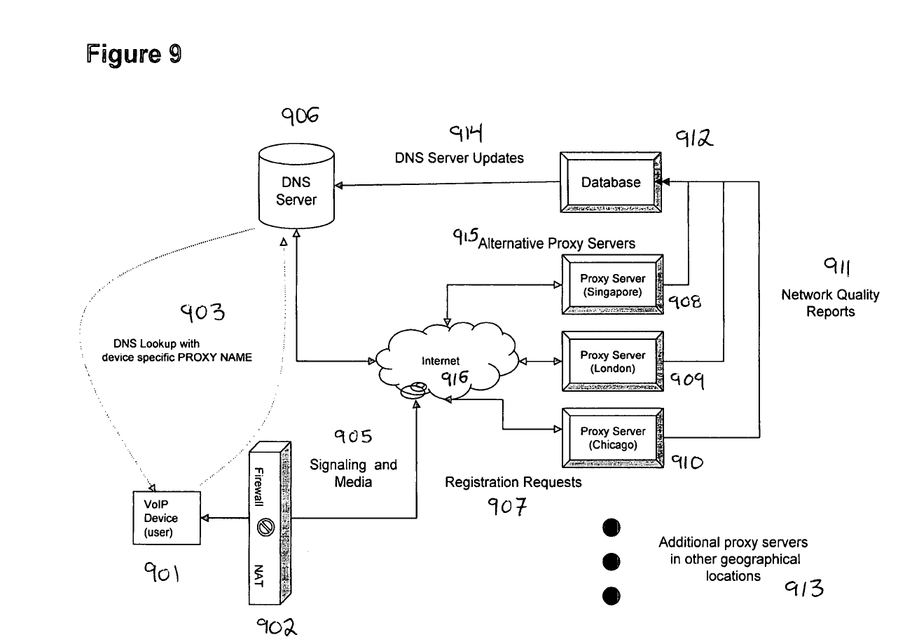

### 9. FIG. 9

FIG. 9 is a graphical illustration of measuring the network quality from a user device to geographically-distributed proxy servers. An ITSP may have alternative proxy servers 915 distributed throughout the world or within a specific geographic region. For example, the ITSP may have a proxy server in Singapore 908, London 909, Chicago 910, and other servers at different geographical locations 913. A user device 901 may be connected behind a NAT or firewall 902 at an unspecified geographical location with unknown network quality through the public Internet 916 to each of the ITSP's proxy servers.

In order to obtain optimized routing and call quality, the ITSP needs to select the proxy server with the best network quality to the user device 901. The best network quality can be calculated based upon the combined values of average delay, jitter, and packet loss between the user device 901 and each of the alternative proxy servers 915. By implementing the systems and methods outlined in FIGS. 1 through 8, the ITSP can the measure the network quality between the user device and proxy servers through the public Internet 916.

The user device implements a configuration file and host name associated with the device for its proxy server. In the system of FIG. 9, the ITSP sets the DNS record on the DNS server for the host name associated with the user device 901 to the IP address of the first proxy server, Singapore 908, and the time-to-live value of the DNS record is specified to a short duration to allow multiple changes to the DNS record within the same day, such as 30 minutes. The device acquires the DNS record for the host name 903, and begins registration with the Singapore proxy server 908.

The device registers approximately once a minute. After a statistical sample of data is acquired to measure the network delay, jitter, and packet loss, such as approximately 30 samples over 30 minutes, the Singapore proxy server 908 sends a network quality report 911 with the average network delay, jitter, and packet loss to the ITSP database 912. The ITSP then updates the DNS record on the DNS server 906 to specify a different proxy server IP address as the IP address of the proxy host name implemented on the user device, such as the IP address of the proxy server in London 909.

After the validity of the DNS record has timed out due to expiration of the time-to-live value of the DNS record, the user device 901 acquires the updated DNS record for its proxy host name in 903, and the DNS record now specifies the IP address for the host name as the London proxy server 909. The device stops registering with the Singapore proxy 908 and begins registering with the London proxy 909. The device registers approximately once a minute. After a statistical sample of data is acquired to measure the network delay, jitter, and packet loss, such as approximately 30 samples over 30 minutes, the London proxy server 909 sends a network quality report 911 with the average network delay, jitter, and packet loss to the ITSP database 912. The ITSP repeats the process of updating the DNS record and acquiring reports of the network quality to the alternative proxy servers 915 until the network quality has been measured between all relevant proxy servers and the user device.

Although one device is shown, the system outlined in 900 can be applied to multiple user devices simultaneously. Since each user device implements a proxy host name associated with the device, the ITSP can individually adjust the proxy server accessed by the each device or groups of related devices. This allows the measurement and adjustment of the proxy server for a device or groups of related devices without impacting the operation of any other device or groups of related devices on the ITSP's network. For example, a first device that has been connected for many weeks may have already been through the network measurement process outlined in FIG. 9 and the proxy service with the optimal network connection has been identified and implemented by the ITSP for the first device that has been connected for many weeks.

The network quality for a second, new user device at an unknown location should be checked and the host name of the proxy server adjusted for the second, new user device, without affecting the operation of the first device that has been connected for many weeks. Implementing a host name for the proxy that is associated with the device allows the ITSP to adjust the proxy server communicating with the second, new device without affecting the first device connected for many weeks, or affecting any other device on the ITSP network. In a preferred embodiment, the measurement of quality is performed during the least-busy hours for the device, corresponding to the time when it is most likely to be idle and the network quality measurement process would be least likely to impact the operation of the device. Although a single database 912 is shown, a distributed database could be implemented in order to maintain robustness. Likewise, one DNS server 906 is shown, although the DNS server could be a distributed network of DNS servers.

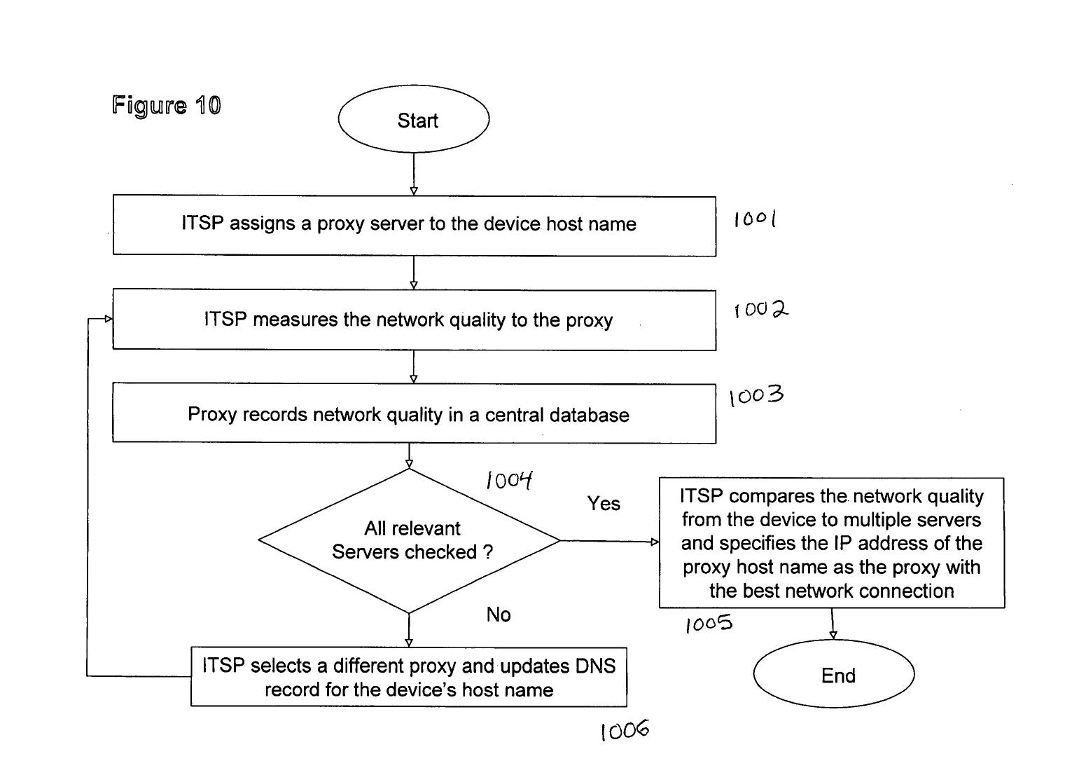

### 10. FIG. 10

FIG. 10 is a simplified block diagram illustrating an exemplary embodiment of selecting the proxy with the highest network quality between the user device and proxy. The system and method of measuring the network quality between a user device and multiple proxy servers is outlined in FIG. 9, and FIG. 10 illustrates the process of selecting the server with the optimal network connection to the user device based upon the measurements in FIG. 9.

At 1001, the ITSP assigns an IP address to the host name associated with the device for the device's proxy. At 1002, the ITSP then measures the quality of the network connection between the device and the proxy server. At 1003, upon acquiring a statistically-valid sample of the network delay, jitter, and packet loss, the proxy server records the measured network-connection quality in a database. At 1004, the ITSP then queries the database to determine if all relevant proxy servers have been checked.

The list of relevant servers in 1004 can be a subset of the list of all possible servers, based on rules established by the ITSP, such as geographical routing or statistical sampling of servers across the ITSP's network. Alternatively, the list of all relevant servers in 1004 may be all of the proxy servers on the ITSP's network. If all relevant servers have not been checked, at 1006, the ITSP selects a different proxy server to communicate with the device, and sets the IP address of that server as the DNS record for the host name for the proxy server implemented by the device. The new DNS record will be queried by the device when the time-to-live parameter of the DNS record has expired. The process of changing the IP address of the host name for the proxy server will continue until the network-connection quality between the device and all relevant proxy servers has been checked.

Once all relevant servers have been checked, at 1005, the ITSP queries the database to select the proxy server with the highest quality connection between the proxy server and the user device, and specifies the IP address of the selected proxy as the IP address of the DNS record for the host name. Although the process of FIG. 10 for initially selecting the proxy server with the highest quality connection is illustrated, the process could periodically be repeated to ensure that the proxy with the highest quality connection is maintained.

The routing rules on the public Internet are in a constant state of flux, and ISPs frequently change their routing. In addition, the quality of routes may change over time, such as congestion during the peak days of the week or hours of a day, and subsequently the process of FIG. 10 may need to be periodically repeated by the ITSP in order to ensure that the best possible proxy is selected. In addition, the ITSP may add new proxy servers to its network that may be relevant to the user device, such as being in the same geographical region as the end user, so the process of FIG. 10 may need to be repeated once additional proxy servers become available.

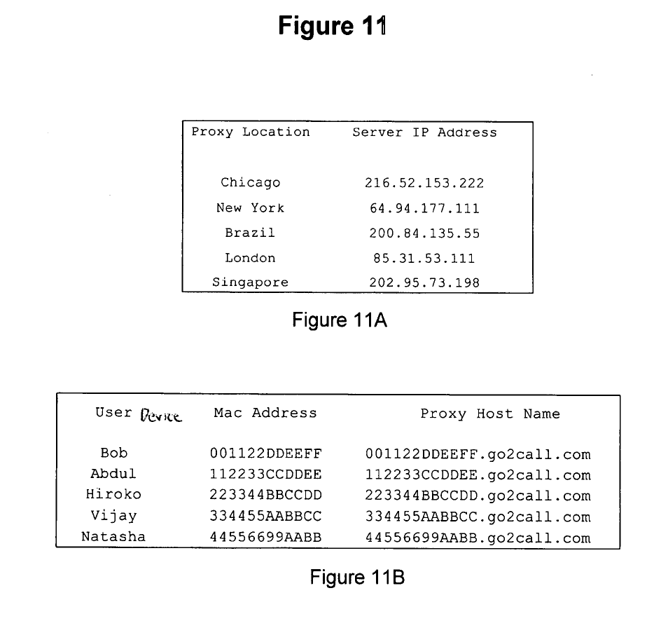

### 11. FIG. 11

FIG. 11 is an illustration of database tables of an exemplary embodiment for tracking proxy servers and device host names. In order to effectively and automatically manage a network of multiple user devices and proxy servers, the ITSP may implement a database to record the relevant information, such as the database shown in 912. By populating the database with lists of all servers, users, device host names, DNS records, and quality measurements, the ITSP can run sophisticated queries such as structured query language (SQL) commands to manage the performance of the network by specifying the servers used by either individual user devices or groups of user devices. In addition, tracking the relevant information in a database allows reporting on the network performance.

FIG. 11A is an example table to associate the IP addresses of proxy servers with the physical location of the server, as well as track all available proxy servers on the ITSP's network. The table in FIG. 11A could be utilized to select the relevant servers for a device at step 1004 of FIG. 10, for example. If the user device is known to belong in a certain hemisphere of the world, the ITSP can specify that the relevant servers to check are the servers in the same hemisphere, which would be a subset of the list of servers in FIG. 11A. Although only a few servers are shown in 11A, the ITSP's network may contain hundreds of servers or more.

FIG. 11B is an illustration of a database table to associate users with devices and host names for the proxy on each device. Devices are shown according to the MAC address, but other parameters could be used, such as a manufacturing serial number, or the devices' public IP address subnet, as examples. Table 11B could be updated with inserted records as new users purchase service and devices are added to the network, or if a user changes devices. The device-specific host name for each user device is also shown as the MAC address for the subdomain, the ITSP name as the primary domain, and “.com” as the top-level domain. As highlighted herein, other naming schemes could be utilized to create host names that are associated with user devices. Although only a few users and devices are shown in 11B, the ITSP's network may contain millions of user devices or more. The proxy host name does not have to be unique in order to be associated with the user device. Alternatively, a unique host name could be implemented by the ITSP according to a preferred embodiment.

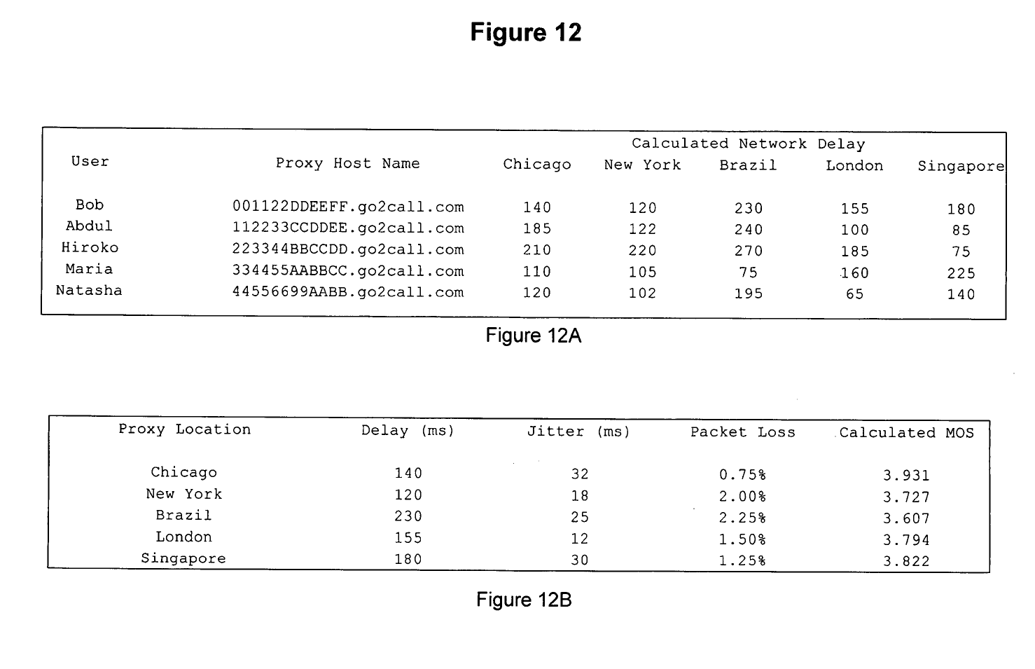

### 12. FIG. 12

FIG. 12 is an illustration of database tables of an exemplary embodiment for recording the network delay across multiple devices and proxies, as well as calculating the mean opinion score. In addition to tracking proxy servers and user devices as shown in FIG. 11, the ITSP may want to record the quality measurements of the network connection between the proxy servers and the user devices. By recording the quality measurements in a database table, automated SQL scripts can be run to update the DNS server with the relevant proxy server to use for each host name associated with a device or groups of related devices. In addition, the database tables shown in FIG. 12 can serve as a central repository of the data gathered by each of the individual proxy servers.

FIG. 12A is an example of a database table to record the delay between each of the proxy servers in 11A and the user devices in 11B. FIG. 12A could be periodically updated as proxy servers report additional statistical measurements of the delay between the user device and the corresponding proxy. Although FIG. 12A is illustrated as fully populated, measurements between all devices and all servers may not be required by the ITSP. In addition, the ITSP may have many more devices and servers than are shown in 12A, which is for illustrative purposes. In the example of FIG. 12A, the end user Bob with a corresponding proxy host name 001122DDEEFF.go2call.com has the lowest network delay between Bob's device and the ITSP proxy in New York, which is measured to be 120 milliseconds. The end user Abdul with the corresponding proxy host name 112233CCDDEE.go2call.com has the lowest network delay to Singapore, which is measured to be 85 milliseconds, in this example.

FIG. 12B is a calculation of the mean opinion score for the network quality from multiple proxy servers to a single user device. In general, the determination of the optimal server for any individual user device will require more than just the network delay shown in FIG. 12A. As noted previously, the quality of the voice or video stream transmitted will be impacted by not only the delay, but also by the jitter and the packet loss. So, to determine the proxy server with the highest overall network quality for the media between the proxy and the user device, the ITSP may implement a calculation that combines the effect of delay, jitter, and packet loss.

Mean opinion score, or MOS, is a measure that is well known in the art for representing audio fidelity, and combines all factors that impact the quality of a transmitted voice stream, with a higher number indicating superior quality on a scale from 1 to 5. The MOS calculated in FIG. 12B is according to the E-model described by the International Telecommunication Union Application of the e-model: A planning guide. Recommendation G.108, Telecommunication Standardization Sector of ITU, Geneva, Switzerland, September 1999, although other calculations for the MOS could be utilized. The example data shown in FIG. 12B is for the overall network quality between the proxy servers and Bob's user device as shown in FIG. 12A.

Note that inclusion of the measured packet loss in the Calculated MOS shows that the ITSP should use a server different than server with simply the lowest network delay shown in FIG. 12A. If only network delay was considered, the ITSP would select New York as the optimal server. However, by including packet loss, the server with the best network connection to Bob's device is the Chicago server. The reason is the packet loss between Bob's device and Chicago is measured to be 0.75%, while the packet loss between Bob's device and New York is measured to be 2.00%. The lower packet loss to Chicago more than compensates for the slightly higher delay to Chicago, and subsequently the ITSP should select the IP address of the Chicago server as the IP address of the host name for Bob's device. Thus, automated calculations of network quality that combines delay, jitter, and packet loss are a preferred embodiment for comparing the network quality between proxy servers and a user device. Note as well that “network quality” and “network-connection quality” are used interchangeably herein.” In addition, measures of jitter, packet loss, and the calculation of MOS could optionally be omitted. Other measures of network quality could also be implemented, such as measurement of bit errors or out-of-order packets.

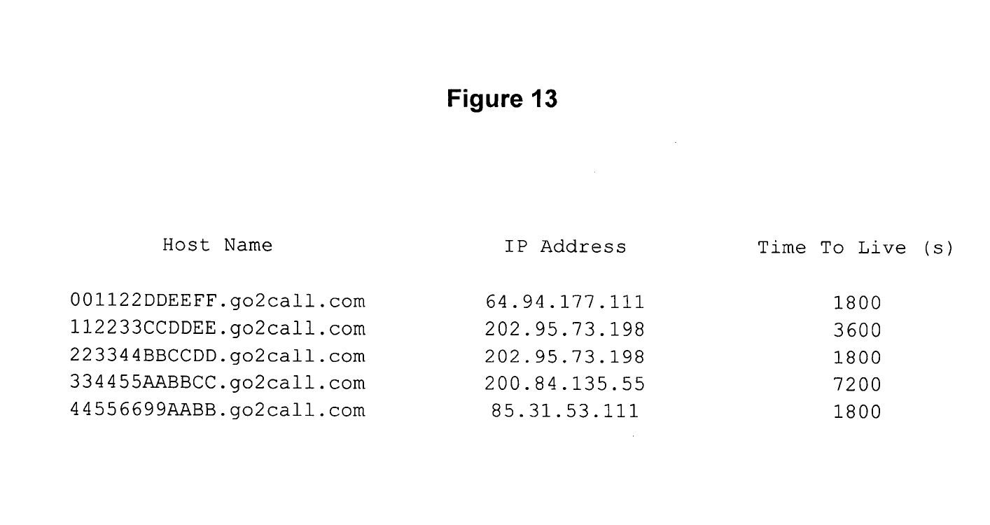

### 13. FIG. 13

FIG. 13 is an illustration of a database table for assigning IP addresses to device host names. Once the ITSP has gathered data regarding the network-connection quality data between the user devices and proxy servers, the DNS server should be periodically updated to reflect the optimized routing from user devices to proxy servers. As explained herein, the IP addresses of the proxy server with the highest quality connection will be assigned to the each device by updating the IP address of the device specific host name for the proxy in the DNS server.

FIG. 13 illustrates an example table associating device host names and server IP addresses, as well as the time-to-live value for the DNS record. A table such as that depicted in FIG. 13 can be automatically generated by running SQL queries against other tables in the database, such as the tables shown in FIG. 11 and FIG. 12. In a preferred embodiment, the IP address specified is the server with the highest calculated MOS to the device, with the MOS determined from network quality measurements for average delay, jitter, and packet loss. The time-to-live parameter specifies the duration of the validity of the DNS record in seconds, and can be used by the ITSP to effectively manage the frequency upon which devices query their corresponding host records.

In a preferred embodiment, the time-to-live value is initially set to 1800 seconds in order to facilitate changes in the IP address of the device's proxy every 30 minutes. Once the optimal server is specified with a stable and high-quality network connection, the time-to-live value of the DNS record can be increased, since the ITSP may not anticipate the need to change the IP address of the device host name as frequently as is required during the initial proxy-server-selection process. Other rules and logic can be applied in the SQL queries to create FIG. 13 besides the calculation of the highest quality server for each device. For example, if the difference in quality between two different servers is low, then the ITSP may intentionally select the server with a lower quality in order to obtain other benefits such as load balancing or reducing network costs.

FIG. 13 also corresponds to the data necessary to operate the DNS server for the ITSP, and the equivalent data will likely reside on both the database and the DNS server. The ITSP can run batch processes to update the information in the DNS server on a periodic basis, such as every five minutes. Alternatively, the DNS server could be programmed to query the database directly every time a new DNS query for a device-specific host name arrives at the DNS server. Although only a few host names are shown in FIG. 13, the example table can be expanded to include millions of host names associated with devices. In addition, although the time-to-live parameter is shown, other DNS parameters could be implemented, such as a DNS server IP address specific to the host name in order to obtain load balancing and distribute the load of DNS queries across multiple DNS servers. Although only one IP address is shown for each device host name, multiple server IP addresses could be listed, such as primary, secondary, tertiary, etc.

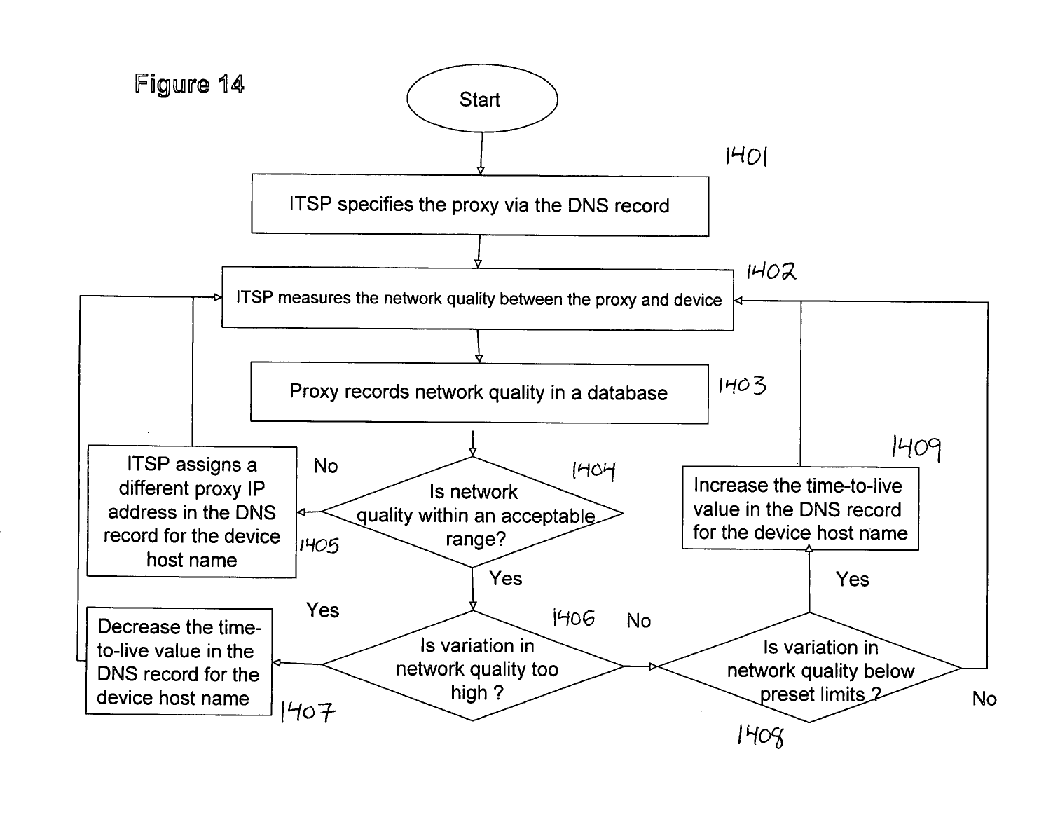

### 14. FIG. 14

FIG. 14 is a simplified block diagram illustrating logic to adjust the “time to live” parameters of the DNS value, based upon the variability of measured network quality between proxy servers and a user device. Once the ITSP has selected the proxy server with the highest-quality network connection to the user device, the ITSP may want to monitor the quality of the connection for the device, as well as all other devices on its network. FIG. 14 illustrates the process an ITSP could implement for monitoring the quality of connections and managing the network based upon the data gathered.

At 1401, the ITSP specifies the proxy for the device via the DNS record. At 1402, the ITSP measures the quality of the network between the device and the proxy server, using the techniques explained herein. At 1403, the proxy server records the network quality measurement data in a database. At 1404, the ITSP determines if the quality is within an acceptable range. In a preferred embodiment, the acceptable network quality would be a MOS of 3.6 or greater. If the network quality is not within the acceptable range, the quality has degraded to the point where another server should be selected as the proxy for the user device, and, at 1405, the ITSP assigns a different proxy iP address in the DNS record for the device host name.

If the network quality is within an acceptable range, the ITSP can then, at 1406, evaluate variation in the network quality. If the variation in the network quality is too high at 1406, the time-to-live value for the DNS record could be decreased at 1407. Variation could be a measure of the standard deviation in the average delay from one set of network measurements to the next. High variation in average delay indicates that the network connection is less stable, such as an average delay of 100 milliseconds over 30 samples during a first 30 minute interval and an average delay of 250 milliseconds over 30 samples during a second 30 minute interval. The benefit of reducing the time-to-live (TTL) value is that a shorter value facilitates more rapid changes in the IP address of the device host name. The tradeoff for short TTL values is that the user device will be querying the DNS server more frequently, generating excess load on the network and DNS servers.

After the TTL value is decreased at 1407, the process returns to 1402, and measurements of the network quality continue. Note that the ITSP could implement a reasonable lower limit on the value of the TTL parameter at 1407, such as 30 seconds. In common practice, a device should not need to register more frequently than every 30 seconds, and there is limited practical value of reducing the TTL value below the device-registration interval.

If the variation in network quality is not too high at 1406, the ITSP could determine if the variation in network quality is above preset limits at 1408. In a preferred embodiment, the preset limits for acceptable variation in the network quality would be if the standard deviation in the average delay is below 30 milliseconds. If the variation in network quality is below preset limits, the ITSP can increase the time-to-live value of the DNS record for the device host name at 1409. In a preferred embodiment, the ITSP can also set a maximum upper limit for the TTL value of the DNS record, such as 6 hours. If the variation in network quality is not below preset limits, no action is taken on the TTL value, and the ITSP continues to measure the network quality between the device and the proxy server at 1402. Although FIG. 14 is shown for a single device, the process can be simultaneously run for multiple devices across multiple proxy servers.

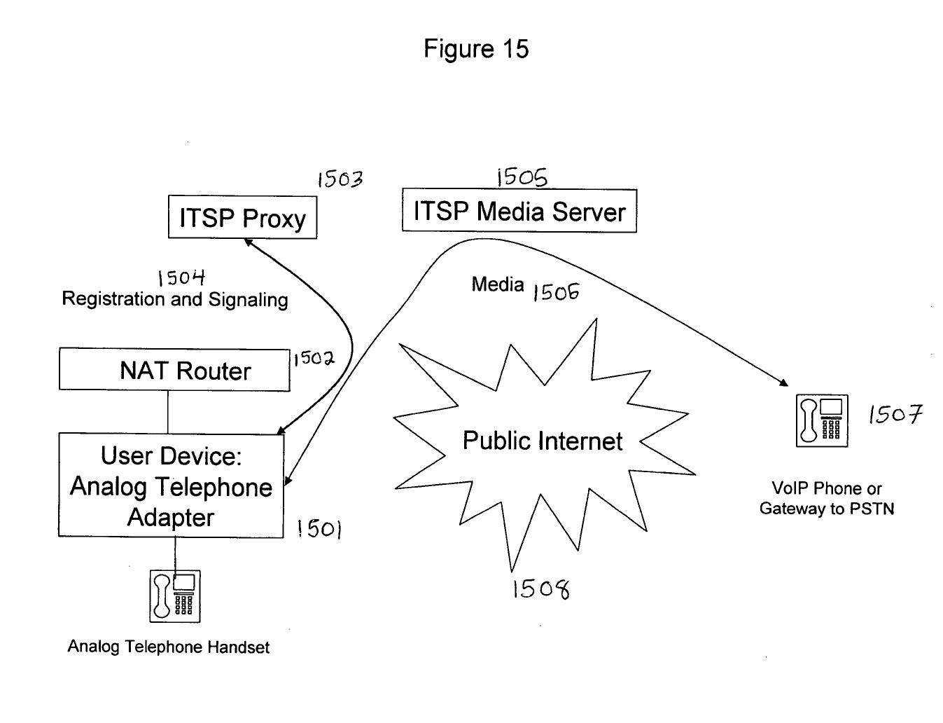

### 15. FIG. 15

FIG. 15 is a simplified network diagram illustrating an exemplary embodiment for the use of a media server. In some embodiments, the ITSP may separate the call control and signaling from the voice or video media. If media is processed by a different server than the proxy server, the ITSP is primarily concerned with the network quality from the user device to the media server. Reasonable levels of network delay, jitter, and packet loss may have no noticeable affect on the call control for the end user, while network delay, jitter, and packet loss will affect the quality of the media, and thus the ITSP should measure the quality of the network from the user device to the media server.

The user device 1501 is connected to the public Internet 1508 behind a NAT router 1502. Although a NAT router is shown, it could be omitted. Registration and call signaling requests 1504 are passed between the user device 1501 to an ITSP proxy 1503. Then a call with another user device 1507 is established, and media 1506 passes through an ITSP media server 1505. The media server could be a relay, which would be required if both devices are behind symmetric NATs. The media server could also be a gateway to the PSTN, a server to transcode codecs to ensure compatibility of media formats between two user devices, a server which the media passes through in order for the ITSP to monitor the quality of the call, or any other server on the ITSP's network that the media traverses Alternatively, the media server and proxy could be combined into a single outbound proxy for the device, which is well known in the art.

The media server 1505 is associated with the proxy server 1503, since the proxy server 1503 may select the media server 1505 upon receipt of a call request from the user device 1501. The call request may be an incoming call from the public Internet 1508 to the user device 1501 or an outgoing call from the user device 1501 to another user device such as a VoIP Phone or gateway to the PSTN 1507. Although a single user device, NAT router, ITSP proxy, ITSP media server, and VoIP phone or PSTN gateway are shown, each of these elements may represent a plurality of respective devices. In addition, the VoIP Phone or gateway 1507 to the PSTN may be serviced by a second ITSP with its own proxy and media servers, and the flow of calls between two ITSPs' servers may be required to establish calls between the user device 1501 and the VoIP Phone or gateway 1507 to the PSTN.

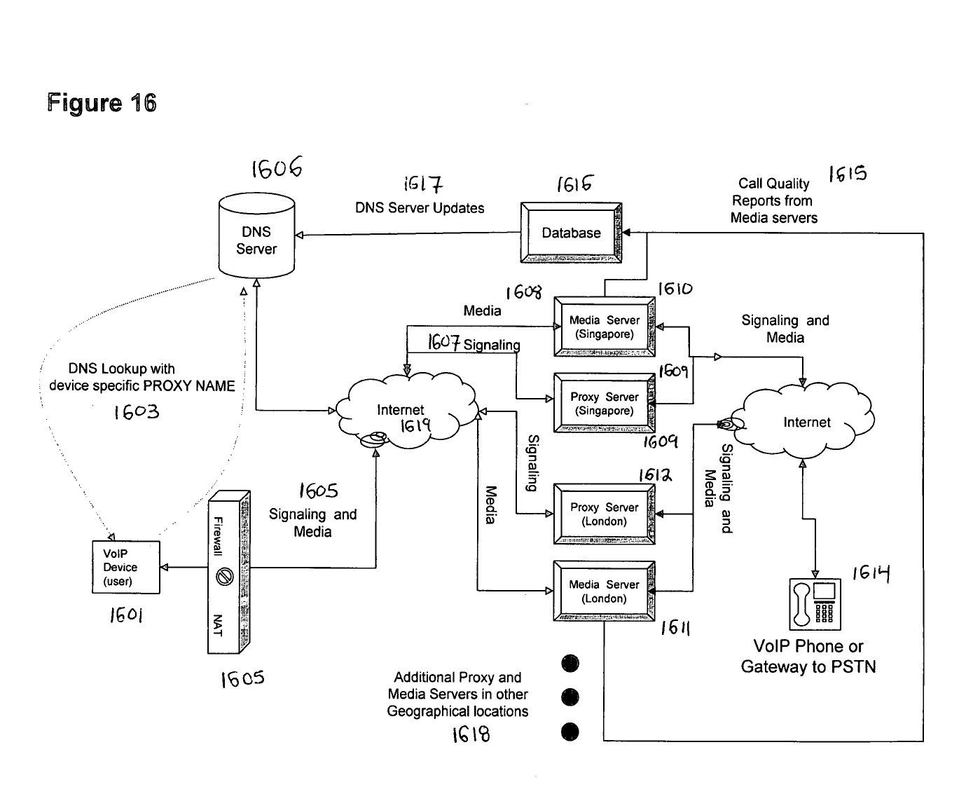

### 16. FIG. 16

FIG. 16 is an illustration of an exemplary embodiment where media servers associated with proxy servers report call-quality statistics. An ITSP may have alternative proxy servers 1609 and 1612 distributed around the world or within a specific geographic region. The ITSP may also have media servers 1610 and 1611 distributed around the world or within a specific geographical region. The media servers are associated with the proxy servers, since media servers may be selected by the proxy server to process the media for individual call requests. The media 1608 for a call between a user device 1601 and another device such as a VoIP phone or PSTN gateway 1614 may flow through a media server. By separating the media 1608 from the signaling 1607, the ITSP can implement specialized servers that are optimized to handle the signaling and media packets.

In a preferred embodiment, the ITSP may have a proxy server 1609 in Singapore and media server 1610 in Singapore, a proxy server 1612 in London and media server 1611 in London, and additional proxy and media servers 1618 in other geographical locations. The user device 1601 may be connected behind a NAT or firewall 1605 at an unknown geographical location with unknown network quality through the public Internet 1619 to each of the ITSP's proxy and media servers. In order to obtain optimized routing and call quality for the media, the ITSP needs to select the media server with the best network quality to the user device 1601. The best network quality can be calculated based upon the combined values of average delay, jitter, and packet loss between the user device 1601 and each of the alternative media servers 1610, 1611, and 1618. By measuring the network delay, jitter, and packet loss for media packets passing through the media servers, the ITSP can determine the network quality between the user device and media servers through the public Internet 1619.

The user device 1601 implements a configuration file and a host name associated with the device for the proxy server. In the system of FIG. 16, the ITSP sets the DNS record on the DNS server 1606 for the host name to the IP address of the first proxy server, Singapore 1609, and the time-to-live value of the DNS record is specified to a short duration, such as 30 minutes. The device acquires the DNS record for the host name 1603, and begins registration with the Singapore proxy server 1609. The ITSP associates the Singapore proxy server 1609 with the Singapore media server 1610, such that the media for calls to or from the user device 1601 will pass through the media server 1610.

Although the media server 1610 is shown as being in the same geographical location as the proxy server 1609, the media server could be anywhere in the world. Wherever the media server is located, the proxy server will have media servers associated with it, since the proxy server may specify the media server to handle the media for a call. Upon a call request to or from the user device 1601, the Singapore proxy 1609 selects a media server to process the media, which is the Singapore media server 1610 in the present example, although another media server could be selected by the proxy server such as a media server in another location 1618.

Upon establishment of a call between the user device 1601 and a second device 1614, the Singapore media server 1610 records the network-quality values such as delay, jitter and packet loss, and records a call quality report 1615 in a database 1616. Since packetized media is transmitted at multiple packets per second, a statistical profile of the quality of the network connection between the media server and the user device can be acquired from a single call lasting more than a few seconds. After sufficient data on the network quality between the user device 1601 and the media server 1610 is acquired, the ITSP can evaluate the data to determine if a different media server may be required to improve call quality. If the network quality is below predefined limits or the ITSP wants to sample the network quality to a different media server, the ITSP then updates the DNS record on the DNS server 1606 to specify a different proxy server IP address as the IP address for the proxy host name implemented on the user device, such as the IP address of the proxy server 1612 in London.

After the validity of the DNS record has timed out due to expiration of the time-to-live value of the DNS record, the user device 1601 acquires the updated DNS record for its proxy host name in 1603, and the DNS record now specifies that the IP address for the host name is the London proxy server 1612. The device stops registering with the Singapore proxy 1609 and begins registering with the London proxy 1612. Upon a call request to or from the user device 1601, the London proxy 1612 selects a media server to process the media, which is the London media server 1611 in the present example, although another media server could be selected to process the media.

Upon establishment of a call between the user device 1601 and a second device 1614, the London media server 1611 records the network-quality values such as delay, jitter and packet loss, and records a call quality report 1615 in a database 1616. After sufficient data on the network quality between the user device 1601 and the media server 1611 is acquired, the ITSP can evaluate the data to determine if a different media server may be required to improve call quality. If the network quality is below predefined limits or the ITSP wants to sample the network quality to a different media server, the ITSP then updates the DNS record on the DNS server 1606 to specify a different proxy server IP address as the IP address for the proxy host name implemented on the user device 1601, such as the IP address of the proxy server 1618 in another geographical location. The ITSP repeats the process of updating the DNS record and acquiring reports of the network quality to the media servers 1610, 1611, and 1618 until the network quality has been measured between all relevant proxy servers and the user device.

Although one device is shown, the system of FIG. 16 can be applied to multiple user devices simultaneously. Since each user device implements a proxy host name that is specific to that particular user device, the ITSP can individually adjust the proxy server accessed by the each device. This allows the measurement and adjustment of the proxy server for a given user device without impacting the operation of any other user device on the ITSP's network. And although a single database 1616 is shown, a distributed database could be implemented for robustness, among other purposes. Likewise, one DNS server 1606 is shown, although the DNS server could be a distributed network of DNS servers.

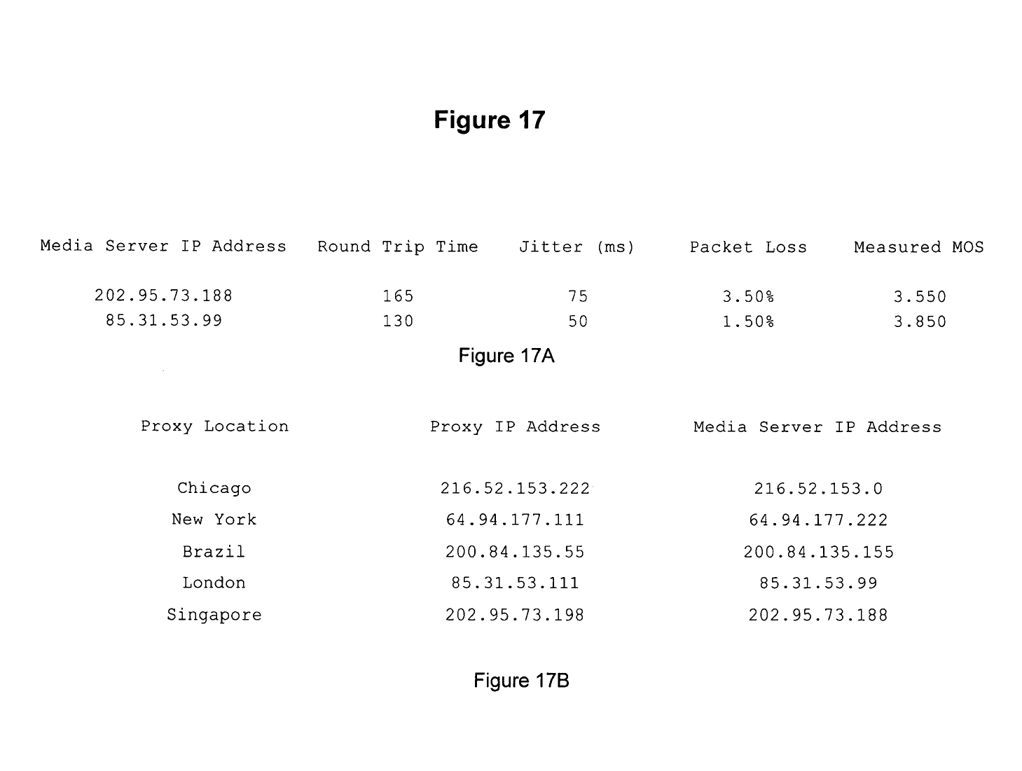

### 17. FIG. 17

FIG. 17 is an illustration of a database for recording the call-quality data from media servers and associating media servers with proxy servers. In order to effectively and automatically manage a network of multiple user devices, proxy servers, and media servers, the ITSP may implement a database to record the relevant information, such as the database shown at 1616. By populating the database with lists of all proxy servers, media servers, users, device host names, DNS records, and quality measurements, the ITSP can run sophisticated queries such as structured query language (SQL) commands to manage the network. In addition, tracking the relevant information in a database allows reporting on the network performance.

FIG. 17A is an example table to associate the network quality between various media servers and a user device. Based on the call-quality reports from the media servers, which report the delay, jitter, and packet loss, the ITSP can also calculate the MOS, which represents the combined effect of delay, jitter, and packet loss to obtain a single aggregate measure of the network quality between the device and the media servers shown in FIG. 17A. The table could be extended to record the network quality for additional media servers, and multiple versions of table 17A could be implemented to track the network quality for multiple user devices. In addition, other measures of network quality could be recorded such as bit error rates, out-of-order packets, or the signal-to-noise ratio of the media.

FIG. 17B is an example table to associate proxy servers and proxy-server IP addresses with media-server IP addresses. This table may be useful for the ITSP to manage updates of the DNS records for the host names implemented on devices, using the network quality reported by the media servers. Although one proxy server and one media server is shown for each proxy location, multiple proxy servers and multiple media servers could be associated with each location. Likewise, the table could be extended to include additional geographical locations. In FIG. 17A, the media server with the superior network quality, as determined by the MOS, is the media server at the IP address 85.31.53.99. To select this server to process media and provide the highest call quality for the user device, the ITSP can run a database query to specify that the DNS record for the host name of the device should resolve to the proxy-server IP address 85.31.53.111, and the DNS server can be updated accordingly.

By measuring the call quality through a media server, the ITSP can apply the techniques for optimizing the network for an individual user device, as highlighted herein. For example, the techniques of monitoring the call quality in FIG. 14 could be applied, so that if the network quality to the media server falls below an acceptable range, the ITSP assigns a different proxy server IP address for the device host name. Subsequent calls with the user device will route through a different proxy with a different associated media server, and the call quality through the new media server will be recorded. The ITSP can then determine the proxy server with the associated media server that provides optimal call quality for the user device.

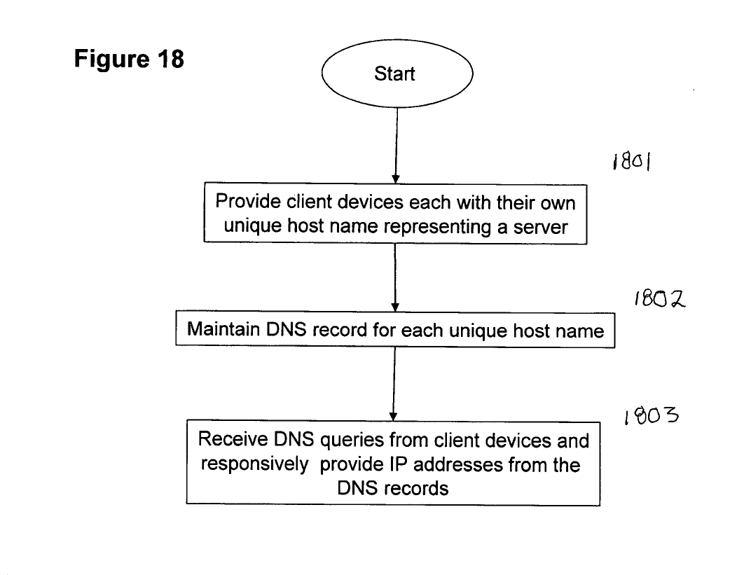

### 18. FIG. 18

FIG. 18 is an illustration of an exemplary embodiment where device-specific host names are used to direct client devices to particular servers. At 1801, each of a plurality of client devices is provided with a host name that is unique to that particular client device. Each of these client-device-specific host names represents a server for the particular client device to contact for carrying out a particular function. Thus, in one embodiment, the client-device-specific host name is essentially a parameter that a given client device will use to contact a server for carrying out the particular function. As an example, as explained above, this device-specific host name could be of the form: “client-device-MAC-address.domain.com.”

Note that the client devices referenced by the method of FIG. 18 could be any client devices capable of communication over the Internet or another circuit-switched or packet-switched network with one or more servers, and of carrying out the client-device functions described herein. As one example, a client device could be a telephony user device as described herein, such as a packet-based telephone, an ATA, a modem, etc. As further examples, one or more of the client devices could be a computer, a laptop computer, a server, a mobile station, an appliance, and/or a digital video recorder. And other examples are certainly possible as well.

With respect to the particular function the client device would carry out at least in part by contacting the server, this would likely depend on what type of client device is used in a particular implementation. For example, if the client device is a telephony user device, the function could be to contact a proxy server or media server as part of establishing or conducting a packet-based video and/or voice session. If the client device is an appliance, the function may be related to reporting device parameters, troubleshooting or diagnosing a problem, running a test, and/or any other type of function. With respect to digital video recorders, the function could be related to downloading program-guide information, and/or any other function. And many other examples are possible as well as to why a client device would contact a server.

At 1802, a Domain Name System (DNS) record is maintained for each unique host name. As is typical in DNS implementations, each DNS record associates a respective unique host name with a respective IP address of a server. Thus, on the server/network side, network administrators may dynamically determine with which server each client-device-specific host name will be associated. This flexibility may be leveraged for any purpose, such as improved routing, determining what function, test, etc. a given client device will engage in at a given time, and/or any other purpose that may be served by directing client devices to different servers with the granular control that client-device-specific host names provides.

At 1803, DNS queries are received from client devices. Each of these DNS queries requests the IP address associated with the host name that is unique to the client device that sent the DNS query. Further at 1803, those IP addresses are responsively provided to the client devices, perhaps in the form of DNS reply messages. Each client device then responsively uses the provided IP address to contact the indicated server for carrying out the particular function that the client device wants to carry out.

As an exemplary implementation of the method of FIG. 18, imagine two client devices A and B. Client device A would be provided with a host name such as “A.domain.com,” while client device B would be provided with a host name such as “B.domain.com.” Note that these host names are not for other devices to use in finding client devices A and B using a system such as DNS. Rather, these are host names for each of client devices A and B to use to contact some network entity other than themselves.

Thus, a DNS record for “A.domain.com” could point to a server C, a server D, or even to client device B. Similarly, a separate DNS record would be maintained for “B.domain.com,” which could point to server C, server D, client device A, or some other server or network device.

In operation then, when client device A carries out a particular function that involves contacting a network entity external to itself, it may do so in part by making a DNS query for “A.domain.com.” Client device A will thus contact whatever entity is currently indicated in the DNS record for “A.domain.com.” Similarly, when client device B carries out that same function or some other function that involves contacting a network entity external to itself, it may do so by making a DNS query for “B.domain.com.” Client device B will thus contact whatever entity is currently indicated in the DNS record for “B.domain.com.” Thus, by managing those two DNS records, client devices A and B can be directed to the same or different network entities, as each client device uses a client-device-specific host name.

### 19. Conclusion

Various exemplary embodiments have been described above. Those skilled in the art will understand, however, that changes and modifications may be made to those examples without departing from the scope of the claims.

What is claimed is:

1. A method for selecting a packet-switched Voice over Internet Protocol (VoIP) proxy server, the method comprising in combination:
assigning a host name to a user device, wherein the host name represents a proxy server for communicating call control with the user device, and wherein the host name is associated with the user device;
acquiring an Internet Protocol (IP) address of a first proxy server via a first Domain Name System (DNS) query for the host name;
measuring a quality of a first network connection between the first proxy server and the user device at least in part by calculating a round-trip delay for messages between the first proxy server and the user device;
changing a DNS record for the host name to specify an IP address of a second proxy server for communicating call control with the user device;
acquiring the IP address of the second proxy server via a second DNS query for the host name;
measuring a quality of a second network connection between the second proxy server and the user device at least in part by calculating a round-trip delay for messages between the second proxy server and the user device;
comparing the quality of the first and second network connections; and
assigning to the DNS record for the host name the IP address of the proxy server associated with the higher-quality network connection.

2. The method of claim 1, wherein a DNS server for the user device is operated by an Internet Telephony Service Provider (ITSP).

3. The method of claim 1, wherein the messages between the user device and the proxy servers conform to at least one protocol selected from the group consisting of the Session Initiation Protocol (SIP), the Inter-Asterisk eXchange (IAX) protocol, International Telecommunications Union (ITU) H.323, the Media Gateway Control Protocol (MGCP), and the Extensible Messaging and Presence Protocol (XMPP).

4. The method of claim 1, further comprising reducing a time-to-live value of the DNS record if higher variation in network quality is measured.

5. The method of claim 1, further comprising increasing a time-to-live value of the DNS record if reduced variation in network quality is measured.

6. The method of claim 1, wherein calculating the round-trip delay for messages from a proxy server to the user device comprises measuring the elapsed time between (i) the proxy server issuing a challenge to a registration request from the user device and (ii) the proxy server receiving a response to the challenge that was issued by the user device.

7. The method of claim 1, further comprising each proxy server maintaining registration information for the user device.

8. The method of claim 1, wherein the host name is not assigned to any other user device.

9. The method of claim 1, further comprising recording the quality of the first and second network connections in a database.

10. The method of claim 1, further comprising recording the round-trip delay for each proxy server in a database.

11. A method for selecting a packet-switched Voice over Internet Protocol (VoIP) server, the method comprising in combination:
assigning a host name to a computer, wherein the host name represents a first proxy server for communicating call control with the computer, wherein the host name is associated with the computer, and wherein the first proxy server has an Internet Protocol (IP) address;
measuring the network quality from the computer to a first media server associated with the first proxy server;
changing a Domain Name System (DNS) record for the host name to specify an IP address of a second proxy server for communicating call control with the computer;
measuring the network quality from the computer to a second media server associated with the second proxy server; and
selecting the media server with the higher-quality network connection with the computer, and assigning the IP address of the proxy server associated with the selected media server to the DNS record for the host name.

12. The method of claim 11, wherein a DNS server for the computer is operated by an Internet Telephony Service Provider (ITSP).

13. The method of claim 11, wherein the messages between the computer and the media servers conform to at least one protocol selected from the group consisting of the Session Initiation Protocol (SIP), the Inter-Asterisk eXchange (LAX) protocol, International Telecommunications Union (ITU) H.323, the Media Gateway Control Protocol (MGCP), and the Extensible Messaging and Presence Protocol (XMPP).

14. The method of claim 11, further comprising reducing a time-to-live value of the DNS record if higher variation in network quality is measured.

15. The method of claim 11, further comprising increasing a time-to-live value of the DNS record if reduced variation in network quality is measured.

16. The method of claim 11, wherein measuring the network quality from the computer to a given media server comprises measuring at least one of delay, packet loss, bit error rate, jitter, out-of-order packets, signal-to-noise ratio, and mean opinion score (MOS).

17. The method of claim 11, further comprising at least one of each media server and each proxy server maintaining registration information for the computer.

18. The method of claim 11, wherein the host name is not assigned to any other computer.

19. The method of claim 11, further comprising recording the delay and packet loss for each media server in a database.

20. A system for assigning a proxy server to a user device, the system comprising:
a user device for communicating a call over the Internet;
a proxy host name to specify an Internet Protocol (IP) address of a proxy server for the user device, wherein the host name is associated with the user device;
an Internet Telephony Service Provider (ITSP) for providing Internet telephone service to the user device;
a plurality of proxy servers, each having a respective IP address, for accepting registration requests from the user device, and for acquiring measurements of network-connection quality between the respective proxy server and the user device;
a database to record the network-connection-quality measurements acquired by the proxy servers, and to select, among the plurality of proxy servers, the proxy server with a highest-quality network connection with the user device; and
a domain name server for converting the host name into the IP address of the proxy server selected by the database.

21. The system of claim 20, wherein the domain name server is operated by the ITSP.

22. The system of claim 20, wherein messages between the user device and the proxy servers conform to at least one protocol selected from the group consisting of the Session Initiation Protocol (SIP), the Inter-Asterisk eXchange (LAX) protocol, International Telecommunications Union (ITU) H.323, the Media Gateway Control Protocol (MGCP), and the Extensible Messaging and Presence Protocol (XMPP).

23. The system of claim 20, wherein a time-to-live value of a DNS record is reduced if higher variation in network quality is measured.

24. The system of claim 20, wherein a time-to-live value of a DNS record is increased if reduced variation in network quality is measured.

25. The system of claim 20, wherein acquiring measurements of network-connection quality between a proxy server and the user device comprises measuring the elapsed time between (i) the proxy server issuing a challenge to a registration request from the user device and (ii) the proxy server receiving a response to the challenge that was issued by the user device.

26. The system of claim 20, wherein each proxy server maintains registration information for the user device.

27. The system of claim 20, wherein the host name is not assigned to any other user device.

28. A method for directing client devices to particular servers, the method comprising in combination:
providing each of a plurality of client devices with a host name that is unique to each respective client device, wherein each respective host name represents a server for a respective client device to contact for carrying out a particular function;
maintaining a Domain Name System (DNS) record for each unique host name, wherein each DNS record associates a respective unique host name with a respective Internet Protocol (IP) address of a server; and
receiving DNS queries from the client devices, wherein each DNS query requests the IP address associated with the host name that is unique to the client device that sent the DNS query, and responsively providing those IP addresses to the client devices, wherein the client devices responsively use the provided IP addresses to contact the servers for carrying out the particular function.

29. The method of claim 28, wherein at least one client device is a device selected from the group consisting of a telephony device, a computer, a laptop computer, a server, a mobile station, an appliance, and a digital video recorder.
